(19) United States
(12) Patent Application Publication
(10) Pub. No.: US 2025/0108354 A1
(43) Pub. Date: Apr. 3, 2025

(54) SELF-REGENERATIVE INTEGRATED CARBON DIOXIDE CAPTURE

(71) Applicant: The Regents of the University of California, Oakland, CA (US)

(72) Inventors: Kandis Leslie ABDUL-AZIZ, Riverside, CA (US); Seongbin JO, Riverside, CA (US)

(21) Appl. No.: 18/895,746

(22) Filed: Sep. 25, 2024

Related U.S. Application Data
(60) Provisional application No. 63/541,613, filed on Sep. 29, 2023.

(51) Int. Cl. B01J 20/04; B01D 53/14

(52) U.S. Cl. CPC B01J 20/041; B01D 53/1475; B01D 2252/10; B01D 2257/504; B01J 2220/42

(57) ABSTRACT

Certain embodiments of the invention provide multifunctional materials (MFMs) comprising self-regenerative Ni-doped CaTiO₃/CaO for the integrated CO₂ capture and dry reforming of methane (ICCDRM), where CaO is a sorbent for CO₂ capture and Ni-doped CaTiO₃ is a catalyst, to convert two greenhouse gases (CO₂ and CH₄) into syngas (CO and H₂). The incorporation of Ni into CaTiO₃ and in-situ exsolution of Ni from CaNiₓTi₁₋ₓO₃ were investigated. In-situ exsolved Ni nanoparticles, which interact strongly with the host CaTiO₃ perovskite, are evenly distributed throughout the CaTiO₃ under reductive conditions (e.g., under H₂). The exsolved Ni nanoparticles re-dispersed back into the bulk of CaTiO₃ under CO₂ (oxidative condition). Ni-doped CaTiO₃/CaO MFMs show relatively stable CO₂ capture capacity and syngas productivity during 30 cycles of ICCDRM.

### CROSS-REFERENCE TO RELATED APPLICATION

This application claims priority to U.S. Provisional Application No. 63/541,613 that was filed on Sep. 29, 2023. The entire content of the application referenced above is hereby incorporated by reference herein.

### GOVERNMENT FUNDING

This invention was made with government support under 2143578 awarded by the National Science Foundation. The government has certain rights in the invention.

### BACKGROUND

Current materials used for capturing and/or utilizing CO₂ have limitations. For example, conventional CO₂ capturing and/or utilizing approach does not have sufficient multicycle performance for industrial practicality after complete CO₂ desorption, material sintering, and coke deposition, and therefore would experience a sharp decrease in syngas production. New and efficient materials and methods are needed.

### SUMMARY OF THE INVENTION

Certain embodiments of the invention provide a multifunctional composition comprising
a) Nickel (Ni)-doped calcium titanate (CaTiO₃), and
b) calcium oxide (CaO), and/or calcium carbonate (CaCO₃).

Certain embodiments of the invention provide a method of capturing and/or utilizing CO₂, comprising contacting a multifunctional composition described herein with CO₂.

Certain embodiments of the invention provide a method of making a multifunctional composition, comprising:
mixing Ni, Ca and Ti metal precursors, a metal chelating agent, and a polymerization agent in an aqueous solution,
drying the aqueous solution to a dried gel, and
heating the dried gel to produce the multifunctional composition described herein.

Certain embodiments of the invention provide a method as described herein.

Certain embodiments of the invention provide a composition described herein.

Certain embodiments of the invention provide a method of using and/or making the composition as described herein.

### BRIEF DESCRIPTION OF THE FIGURES

The patent or application file contains at least one drawing executed in color. Copies of this patent or patent application publication with color drawing(s) will be provided by the Office upon request and payment of the necessary fee.

FIGS. 1A-1C. FIG. 1A) Schematic of in situ Ni nanoparticle exsolution from Ca₁₊ₓNi_{y}Ti_{1-y}O₃ perovskite and Ni re-incorporation into CaTiO₃ perovskite during ICCDRM process, FIG. 1B) XRD patterns and FIG. 1C) enlarged local XRD pattern of Ca₁Ti₁, Ca₂Ti₁, Ca₂Ni_{0.02}Ti_{0.98} and Ca₂Ni_{0.05}T_{0.95}: CaTiO₃ (red diamond), CaO (blue circle), NiO (green solid square).

FIGS. 2A-2B. Ni 2p_{3/2} XPS spectra of FIG. 2A) as prepared and FIG. 2B) reduced Ca₂Ni_{0.05}, Ca₂Ni_{0.02}Ti_{0.98} and Ca₂Ni_{0.05}Ti_{0.95}.

FIGS. 3A-3B. Ca 2p XPS spectra of FIG. 3A) as prepared and FIG. 3B) reduced CaO, CaTiO₃, Ca₂ Ni_{0.05}, Ca₂Ni_{0.02}Ti_{0.98} and Ca₂Ni_{0.05}Ti_{0.95}.

FIGS. 4A-4B. Ti 2p XPS spectra of FIG. 4A) as prepared and FIG. 4B) reduced CaTiO₃, Ca₂Ni_{0.02}Ti_{0.98} and Ca₂Ni_{0.05}Ti_{0.95}.

FIGS. 5A-5B. O 1s XPS spectra of FIG. 5A) as prepared and FIG. 5B) reduced CaO, CaTiO₃, Ca₂Ni_{0.05}, Ca₂Ni_{0.02}Ti_{0.98} and Ca₂Ni_{0.05}Ti_{0.95}.

FIGS. 6A-6C. STEM-HAADF images of Ca₂Ni_{0.02}Ti_{0.98} MFM in the states of FIG. 6A) as-prepared, FIG. 6B) reduced by H₂ at 800° C., and FIG. 6C) re-oxidized by CO₂ after CO₂ capture at 700° C.

FIG. 7. H₂-TPR profiles of Ca₂Ni_{0.05}, Ca₂Ni_{0.02}Ti_{0.98}, and Ca₂Ni_{0.05}Ti_{0.95} under 10 vol % H₂ from 100 to 800° C.

FIGS. 8A-8B. FIG. 8A) CH₄-TPR under 10 vol % CH₄ from 100 to 800° C. and FIG. 8B) TPO after CH₄-treatement at 800° C. for 1 h over Ca₂Ni_{0.05}, Ca₂Ni_{0.02}Ti_{0.98}, and Ca₂Ni_{0.05}Ti_{0.95}.

FIGS. 9A-9F. HRTEM images of FIGS. 9A-9B) Ca₂Ni_{0.05}, FIGS. 9C-9D) Ca₂Ni_{0.02}Ti_{0.98}, and FIGS. 9E-9F) Ca₂Ni_{0.05}Ti_{0.95} after CH₄-treatment under 10 vol % CH₄/He at 800° C. for 1 h.

FIGS. 10A-10D. FIG. 10A) CH₄-TPSR after CO₂ capture under 10 vol % CH₄/He condition from 100 to 800° C. over Ca₂Ni_{0.02}Ti_{0.98}MFM. CO₂ breakthrough curves and DRM profiles of FIG. 10B) Ca₂Ni_{0.05}, FIG. 10C) Ca₂Ni_{0.02}Ti_{0.98}, and FIG. 10D) Ca₂Ni_{0.05}Ti_{0.95} in the first 2 cycles of ICCDRM at 700° C. (carbonation: 10 vol % CO₂/He and DRM: 10 vol % CH₄/He).

FIGS. 11A-11D. FIG. 11A) CO₂ capture capacity, FIG. 11B) CO productivity, FIG. 11C) H₂ productivity, and FIG. 11D) H₂/CO ratio of Ca₂Ni_{0.05}, Ca₂Ni_{0.02}Ti_{0.98}, and Ca₂Ni_{0.05}Ti_{0.95} during 30 cycles of ICCDRM at 700° C. (CO₂ capture: 10 vol % CO₂/He and DRM: 10 vol % CH₄/He).

FIGS. 12A-12B. Schematics of ICCDRM over FIG. 12A) self-regenerative Ni-doped CaTiO₃/CaO and FIG. 12B) conventional Ni/CaO DFM; dark green (Ca_{1+α}NiₓTi₁₋ₓO₃), cyan (CaO), blue (CaTiO₃), yellow (Ni), purple (CaCO₃), black (coke).

FIGS. 13A-13B (FIG. 13A) XRD patterns and (FIG. 13B) enlarged local XRD pattern of as-prepared and reduced Ca₂Ni_{0.05} DFM: CaO (blue circle), NiO (green solid square), Ni⁰ (empty square, green outline).

FIGS. 14A-14B (FIG. 14A) XRD patterns and (FIG. 14B) enlarged local XRD pattern of Ca₁Ti₁, Ca₁Ni_{0.01}Ti_{0.99} and Ca₁Ni_{0.02}Ti_{0.98}: CaTiO₃ (red diamond), NiO (green solid square).

FIGS. 15A-15B Enlarged local XRD patterns of Ca₂Ti₁, Ca₂Ni_{0.02}Ti_{0.98} and Ca₂Ni_{0.05}Ti_{0.95} in the states of (FIG. 15A) as prepared and (FIG. 15B) reduced: CaTiO₃ (red diamond), NiO (green solid square), and Ni⁰ (empty square, green outline).

FIGS. 16A-16B XPS C 1s spectra of (FIG. 16A) as-prepared and (FIG. 16B) reduced samples.

FIG. 17. STEM-EDS mapping of as-prepared Ca₂Ni_{0.05} DFM.

FIG. 18. STEM-EDS mapping of as-prepared Ca₂Ni_{0.05}Ti_{0.95} MFM.

FIG. 19. STEM-EDS mapping of reduced Ca₂Ni_{0.05}Ti_{0.95} MFM.

FIG. 20. STEM-EDS mapping of reduced Ca₂Ni_{0.02}Ti_{0.98} MFM and Ni nanoparticle size distribution.

FIG. 21. STEM-EDS mapping of reduced Ca₂Ni_{0.05}Ti_{0.95} MFM and Ni nanoparticle size distribution.

FIG. 22. STEM image of reduced Ca₂Ni_{0.02}Ti_{0.98} MFM.

FIG. 23. STEM image of reduced Ca₂Ni_{0.05}Ti_{0.95} MFM.

FIG. 24. STEM image of Ca₂Ni_{0.02}Ti_{0.98} MFM after carbonation.

FIG. 25. STEM image of Ca₂Ni_{0.02}Ti_{0.98} MFM after carbonation.

FIGS. 26A-26D. STEM-EDS mapping of (FIGS. 26A-26B) Ca₂Ni_{0.02}Ti_{0.98} and (FIGS. 26C-26D) Ca₂Ni_{0.05}Ti_{0.95} MFMs after CH₄-treatment under 10 vol. % CH₄/He at 800° C. for 1 h.

FIG. 27. CH4-TPSR over Ca₂Ni_{0.02}Ti_{0.98} MFM after reduction from 100 to 800° C. with temperature ramping of 10° C./min under 10 vol. % CH₄/He.

FIG. 28. CH₄-TPR over bare CaTiO₃ perovskite (Ca₁Ti₁) from 100 to 800° C. with temperature ramping of 10° C./min under 10 vol. % CH₄/He.

FIGS. 29A-29C. CO₂ and O₂ signals of (FIG. 29A) Ca₂Ni_{0.05}, (FIG. 29B) Ca₂Ni_{0.02}Ti_{0.98} and (FIG. 29C) Ca₂Ni_{0.05}Ti_{0.95} during TPO.

FIG. 30. TPD result of Ca₂Ni_{0.02}Ti_{0.98} MFM after CO₂ capture from 100 to 800° C. with temperature ramping of 10° C./min under pure He.

FIG. 31. CO₂ breakthrough curves and DRM profiles of Ca₂Ni_{0.02}Ti_{0.98} MFM at 650° C. (carbonation: 10 vol. % CO₂/He and DRM: 10 vol. % CH₄/He).

FIGS. 32A-32D. XRD patterns of Ca₂Ni_{0.05}, Ca₂Ni_{0.02}Ti_{0.98} and Ca₂Ni_{0.05}Ti_{0.95} (FIGS. 32A-32B) after CO₂ capture and (FIGS. 32C-32D) 30 cycles of ICCDRM at 700° C. (carbonation: 10 vol. % CO₂/He and DRM: 10 vol. % CH₄/He): CaTiO₃ (red diamond), CaO (blue solid circle), CaCO₃ (empty circle, blue outline) and Ni⁰ (empty square, green outline).

FIGS. 33A-33C. (FIGS. 33A-33B) STEM-EDS mapping and (FIG. 33C) HRTEM image of Ca₂Ni_{0.05} DFM after 30 cycles of ICCDRM at 700° C. (carbonation: 10 vol. % CO₂/He for 15 min and DRM: 10 vol. % CH₄ for 15 min).

FIGS. 34A-34C. (FIGS. 34A-34B) STEM-EDS mapping and (FIG. 34C) HRTEM image of Ca₂Ni_{0.02}Ti_{0.98} MFM after 30 cycles of ICCDRM at 700° C. (carbonation: 10 vol. % CO₂/He for 15 min and DRM: 10 vol. % CH₄ for 15 min).

FIGS. 35A-35D. (FIGS. 35A-35B) STEM-EDS mapping and (FIGS. 35C-35D) HRTEM images of Ca₂Ni_{0.05}Ti_{0.95} DFM after 30 cycles of ICCDRM at 700° C. (carbonation: 10 vol. % CO₂/He for 15 min and DRM: 10 vol. % CH₄ for 15 min).

FIGS. 36A-36D. XPS spectra of Ca₂Ni_{0.02}Ti_{0.98} MFM: (FIG. 36A) Ni 2p_{3/2}, (FIG. 36B) Ca 2p, (FIG. 36C) Ti 2p, and (FIG. 36D) O 1s.

FIG. 37. CO₂ capture capacity as a function of cycle numbers of Ni/CaO DFM and Ca₂Ni_{0.05}Ti_{0.95} MFM.

FIGS. 38A-38F. FIG. 38A illustrates the schematic of Ni incorporation into the CaTiO₃ perovskite frameworks and in-situ Ni exsolution from Ca(NiₓTi₁₋ₓ)O₃ double perovskite. Ni-doped CaTiO₃/CaO MFMs were prepared by the citrate sol-gel method for the ICCDRM. Those materials were calcined at 800° C. to incorporate Ni into CaTiO₃ and avoid the formation of perovskite-like structures containing higher Ca/Ti ratio such as Ca₃Ti₂O₇ and Ca₄Ti₃O₁₀, which form at higher temperatures above 1000° C. and are nonreducible materials. FIG. 38B shows XRD patterns. FIG. 38C shows enlarged local XRD pattern of Ca₁Ti₁, Ca₂Ti₁, Ca₂Ni_{0.02}Ti_{0.98}, and Ca₂Ni_{0.05}Ti_{0.95}. Red diamond indicates CaTiO₃, blue circle indicates CaO, green square indicates NiO. STEM images of (FIG. 38E) Ca₂Ni_{0.02}Ti_{0.98}, and (FIG. 38F) Ca₂Ni_{0.05}Ti_{0.95} MFMs after reduction at 800° C.

FIG. 39. FIG. 39 shows the CO₂ capture capacity as a function of the reaction time of Ca₂Ni_{0.05}Ti_{0.95} MFM and Ca₂Ni_{0.05} DFM at the 1st cycle.

FIGS. 40A-40D. FIG. 40 shows the ICCDRM performance such as CO₂ capture capacity and syngas (CO and H₂) productivity of Ca₂Ni_{0.05}Ti_{0.95} MFM at different temperatures (650, 700, and 750° C.). CO₂ capture and syngas productivity were calculated from the CO₂ breakthrough curves and subsequent DRM profiles, respectively. (FIG. 40A) CO₂ capture capacity and syngas (CO and H₂) productivity over Ca₂Ni_{0.05}Ti_{0.95} MFM during ICCDRM at different temperatures (650, 700 and 750° C.), ICCDRM profiles at (FIG. 40B) 650, (FIG. 40C) 700 and (FIG. 40D) 750° C.

FIG. 41. STEM image of Ca₂Ni_{0.02}Ti_{0.98} MFM after reoxidation under CO₂ at 700° C. for 1 h.

FIGS. 42A-42B. Schematic of ICCDRM over Ni-doped CaTiO₃/CaO; (FIG. 42A) CO₂ capture step: Ni/CaTiO₃/CaO(s)+CO₂(g)⇄CaNiₓTi₁₋ₓO₃/CaCO₃(s) and (FIG. 42B) DRM step: CaNiₓTi₁₋ₓO₃/CaCO₃(s)+CH₄(g)⇄Ni/CaTiO₃/CaO(s)+2CO(g)+2H₂(g).

### DETAILED DESCRIPTION

Integrated CO₂ capture and utilization (ICCU) has been studied as one of the promising climate mitigation techniques to produce CO₂-derived fuels or chemicals such as methane, synthetic gas (syngas CO and H₂), light olefins, and methanol, etc. ICCU is a less energy-intensive process compared to conventional CO₂ capture and utilization schemes, where dual functional materials (DFMs, catalysts and CO₂ sorbents) are used to directly convert captured CO₂ into fuels and chemicals without separation and transportation of CO₂ at much lower temperature for regeneration/decarbonation. Ni/CaO-based DFMs have been used in most ICCU processes reported to date due to the catalytic activity of Ni and theoretical CO₂ capture capacity of CaO (17.8 mmol CO2/g CaO), respectively, at a similar range of temperatures (e.g., 500-700° C.).

Integrated CO₂ capture and subsequent DRM (ICCDRM) process using Ni/CaO-based DFMs is a very effective way to convert two greenhouse gases (CO₂ and CH₄) into syngas. ICCDRM showed higher CH₄ conversion than that via partial oxidation of methane by oxygen from NiO, but its efficiency can decrease sharply, and coke is deposited by CH₄ decomposition after complete CO₂ desorption. Although the deposited carbon can be gasified, the coke accumulation during the multicycle ICCDRM reactions is still significant, resulting in gradual decrease in CO₂ capture capacity and catalytic deactivation. For the successful application of DFMs in the ICCDRM, several issues should be resolved such as limited CO₂ capture kinetics and capacity, sintering-induced gradual decrease in CO₂ capture capacity, and deactivation of catalytic activity from sintering of catalysts and coke-deposition.

As described herein, Ni-doped CaTiO₃/CaO nanocomposites as multiple functional materials (MFMs) (e.g., Ca₂Ni_{0.02}Ti_{0.98} and Ca₂Ni_{0.05}Ti_{0.95}) were prepared for ICCDRM. A small amount of Ni can be incorporated into CaTiO₃ perovskite as a CaNiₓTi₁₋ₓO₃ double perovskite because of unstable NiO₆ octahedron. In-situ exsolved Ni nanoparticles, which have strong interaction with host CaTiO₃ perovskite, were evenly distributed throughout the CaTiO₃ under reductive condition (e.g., H₂ or CH₄). The Ni incorporated in the MFMs, such as Ca₂Ni_{0.02}Ti_{0.98}, can be partially regenerated, preserving the overall performance and stability.

Due to the strong metal-support interaction (SMSI), Ni nanoparticles socketed in the CaTiO₃ perovskite can alleviate the Ni sintering. In addition, Ni nanoparticles can be self-regenerated during cycles of CO₂ capture (oxidative condition) and subsequent DRM (reductive condition). The filamentous coke-deposition between Ni and CaTiO₃ would be suppressed because of the strong metal support interaction. The deposited coke encapsulating the Ni nanoparticles during the DRM step can be easily gasified by CO₂ at the subsequent CO₂ capture step. CaTiO₃ intra-region of CaO grains can improve the porous structure of MFMs, thus improving CO₂ capture kinetics as well as thermal stability during the ICCDRM.

As shown in Example 1, Ni-doped CaTiO₃/CaO MFMs showed relatively stable CO₂ capture capacity and syngas productivity during 30 cycles of ICCDRM. The presence of CaTiO₃ between CaO grains alleviated CaO/CaCO₃ thermal sintering from volume expansion. Strong interaction between Ni and CaTiO₃, separation of Ni/CaTiO₃ from CaO/CaCO₃ morphology change, and self-regeneration prevented Ni nanoparticles from sintering. The severe accumulation of coke deposition was mitigated because of the small nanoparticle size of exsolved Ni and the strong interaction with CaTiO₃. Furthermore, the in-situ oxidation of coke by lattice oxygen of CaTiO₃ at the subsequent CO₂ capture step prohibited coke accumulation.

Accordingly, certain embodiments of the invention provide a composition or nanocomposite material that comprises:
a) a Ni-doped CaTiO₃ catalyst material, and
b) a CO₂ sorbent material (e.g., CaO) and/or its derivative thereof after CO₂ capture (e.g., CaCO₃).

In certain embodiments, the composition or nanocomposite material comprises:
a) catalyst material domains (e.g., Ni-doped CaTiO₃ grains), and
b) CO₂ sorbent material domains such as CaO grains and/or its derivative domains thereof after CO₂ capture, such as CaCO₃ grains.

In certain embodiments, the composition comprises:
a) Ni-doped CaTiO₃, and
b) CaO and/or CaCO₃.

As used herein, the terms “Ni-doped CaTiO₃” and “Ni-doped CaTiO₃ perovskite” are used interchangeably and refer to CaTiO₃ perovskite that comprises one or more Ni species (e.g., Ni⁰, Ni²⁺, Ni³⁺, and/or Ni⁴⁺) that is partially submerged (or socketed) on CaTiO₃ surface, or incorporated into CaTiO₃ lattice.

In certain embodiments, the Ni-doped CaTiO₃ comprises Ni (e.g., Ni⁰ and/or NiO) that is socketed on CaTiO₃ surface. In certain embodiments, the Ni-doped CaTiO₃ comprises metallic Ni⁰ that is socketed on CaTiO₃ surface. In certain embodiments, the Ni-doped CaTiO₃ comprises NiO that is socketed on CaTiO₃ surface.

In certain embodiments, the Ni-doped CaTiO₃ comprises Ni (e.g., Ni³⁺, and/or Ni⁴⁺) that is incorporated into the CaTiO₃ lattice.

In certain embodiments, the Ni-doped CaTiO₃ has a Ni to Ti molar ratio of about 1:99 to 3:97. In certain embodiments, the Ni-doped CaTiO₃ has a Ni to Ti molar ratio of about 1:99 to 5:95. In certain embodiments, the Ni-doped CaTiO₃ has a Ni to Ti molar ratio of about 2:98 to 5:95. In certain embodiments, the Ni-doped CaTiO₃ has a Ni to Ti molar ratio of about 3:97 to 5:95. In certain embodiments, the Ni-doped CaTiO₃ has a Ni to Ti molar ratio of about 4:96 to 5:95. In certain embodiments, the Ni-doped CaTiO₃ has a Ni to Ti molar ratio of about 2:98 to 4:96. In certain embodiments, the Ni-doped CaTiO₃ has a Ni to Ti molar ratio of about 2:98 to 3:97.

In certain embodiments, the Ni-doped CaTiO₃ has a Ni to Ti molar ratio of about 1:99.

In certain embodiments, the Ni-doped CaTiO₃ has a Ni to Ti molar ratio of about 2:98.

In certain embodiments, the Ni-doped CaTiO₃ has a Ni to Ti molar ratio of about 3:97.

In certain embodiments, the Ni-doped CaTiO₃ has a Ni to Ti molar ratio of about 4:96.

In certain embodiments, the Ni-doped CaTiO₃ has a Ni to Ti molar ratio of about 5:95.

In certain embodiments, the Ni-doped CaTiO₃ or catalyst domain(s), such as Ni-doped CaTiO₃ grain(s), has a Ca to (Ni+Ti) molar ratio of about 1 to 1.1. In certain embodiments, the Ni-doped CaTiO₃ has a Ca to (Ni+Ti) molar ratio of about 1.01 to 1.1. In certain embodiments, the Ni-doped CaTiO₃ has a Ca to (Ni+Ti) molar ratio of about 1.01 to 1.09. In certain embodiments, the Ni-doped CaTiO₃ has a Ca to (Ni+Ti) molar ratio of about 1.01 to 1.08, 1.02 to 1.08, 1.01 to 1.07, 1.02 to 1.06, or 1.03 to 1.06.

In certain embodiments, the Ni-doped CaTiO₃ or catalyst domain(s), such as Ni-doped CaTiO₃ grain(s), has a Ca to (Ni+Ti) molar ratio of about 1.01. In certain embodiments, the Ni-doped CaTiO₃ has a Ca to (Ni+Ti) molar ratio of about 1.09. In certain embodiments, the Ni-doped CaTiO₃ has a Ca to (Ni+Ti) molar ratio of about 1.02. In certain embodiments, the Ni-doped CaTiO₃ has a Ca to (Ni+Ti) molar ratio of about 1.03. In certain embodiments, the Ni-doped CaTiO₃ has a Ca to (Ni+Ti) molar ratio of about 1.04. In certain embodiments, the Ni-doped CaTiO₃ has a Ca to (Ni+Ti) molar ratio of about 1.05. In certain embodiments, the Ni-doped CaTiO₃ has a Ca to (Ni+Ti) molar ratio of about 1.06. In certain embodiments, the Ni-doped CaTiO₃ has a Ca to (Ni+Ti) molar ratio of about 1.07. In certain embodiments, the Ni-doped CaTiO₃ has a Ca to (Ni+Ti) molar ratio of about 1.08.

In certain embodiments, the Ni-doped CaTiO₃ or catalyst domain(s), such as Ni-doped CaTiO₃ grain(s), comprises Ni that is incorporated into CaTiO₃ lattice and has formula of CaₘNiₓTi₁₋ₓO₃, wherein 1≤m≤1.1 and 0<x≤0.05. In certain embodiments, 1<m≤1.1 and 0<x≤0.05. In certain embodiments, m is about 1.01. In certain embodiments, m is about 1.09. In certain embodiments, x is about 0.01, 0.02, 0.03, 0.04, or 0.05. In certain embodiments, x is about 0.02, or 0.05.

In certain embodiments, the composition (comprising Ni-doped CaTiO₃, and CaO and/or CaCO₃) has a total Ca to (Ni+Ti) molar ratio of about 2:1. In certain embodiments, the composition (comprising Ni-doped CaTiO₃ and CaO) has a total Ca to (Ni+Ti) molar ratio of about 2:1. In certain embodiments, the composition (e.g., MFMs of Ca₂Ni_{0.02}Ti_{0.98}) has a total Ca/Ni/Ti molar ratio of about 2:0.02:0.98. In certain embodiments, the composition (e.g., MFMs of Ca₂Ni_{0.05}Ti_{0.95}) has a total Ca/Ni/Ti molar ratio of about 2:0.05:0.95.

In certain embodiments, the composition (e.g., under reductive conditions) comprises: a) Ni-doped CaTiO₃, and b) CaO, wherein Ni-doped CaTiO₃ comprises Ni that is socketed on the surface of CaTiO₃.

In certain embodiments, the socketed Ni comprises Ni nanoparticles that have a diameter of about 4-12 nm, 5-10 nm, or 6-9 nm. In certain embodiments, the socketed Ni comprises Ni nanoparticles that have an average diameter of about 4, 5, 6, 7, 8, 9, 10, 11, 12, or 13 nm. In certain embodiments, the socketed Ni comprises Ni nanoparticles that have an average diameter of about 6, 7, or 8 nm.

In certain embodiments, the composition (e.g., after CO₂ capture) comprises: a) Ni-doped CaTiO₃, and b) CaCO₃, wherein Ni-doped CaTiO₃ comprises Ni that is incorporated into the CaTiO₃ lattice.

After CO₂ capture, the composition is capable of being regenerated (e.g., during dry reforming of methane CH₄) and the incorporated Ni can be partially exsolved to be socketed on the surface of CaTiO₃. Thus, in certain embodiments, not all incorporated Ni are exsolved during regeneration, for example, during or after regeneration, or after several cycles of integrated CO₂ capture and dry reforming of methane (ICCDRM), the composition may comprise Ni-doped CaTiO₃ domains comprising i) Ni that is socketed on the surface of CaTiO₃, and ii) Ni that is incorporated into CaTiO₃ lattice.

In certain embodiments, the composition does not comprise Ca₃Ti₂O₇ and Ca₄Ti₃O₁₀. In certain embodiments, the composition is substantially free of Ca₃Ti₂O₇. In certain embodiments, the composition is substantially free of Ca₄Ti₃O₁₀.

In certain embodiments, the composition (e.g., prior to being treated under reductive condition such as contacting with H₂, and prior to CO₂ capture) comprises: a) Ni-doped CaTiO₃, and b) CaO, wherein Ni-doped CaTiO₃ comprises Ni that is incorporated into the CaTiO₃ lattice.

### Methods

Certain embodiments of the invention provide a CO₂ capture and/or utilization method (e.g., ICCDRM) comprising contacting a composition or nanocomposite material described herein with CO₂.

For example, a composition (comprising Ni-doped CaTiO₃, and CaO) is contacted with CO₂. In certain embodiments, the Ni-doped CaTiO₃ comprises Ni that is socketed on the surface of CaTiO₃ prior to contacting CO₂. In certain embodiments, the previously socketed Ni is incorporated into CaTiO₃ lattice after contacting CO₂. In certain embodiments, CaO is converted to CaCO₃ after contacting CO₂.

In certain embodiments, contacting CO₂ is conducted at a temperature of about 500-900° C., 500-700° C., 600-850° C., 650-800° C., 700-900° C., 700-850° C., or 650-800° C. In certain embodiments, contacting CO₂ is conducted at a temperature of about 500, 550, 600, 650, 700, 750, 800, 850, or 900° C. In certain embodiments, contacting CO₂ is conducted at a temperature of about 700, 750, or 800° C.

In certain embodiments, the method further comprises contacting a composition (comprising Ni-doped CaTiO₃, and CaCO₃) with methane. In certain embodiments, Ni is incorporated within CaTiO₃ lattice prior to contacting CH₄. In certain embodiments, the incorporated Ni within CaTiO₃ lattice is exsolved or converted to socketed Ni on the surface of CaTiO₃ after contacting CH₄. In certain embodiments, one or more syngas is produced. In certain embodiments, CO and H₂ are produced.

In certain embodiments, contacting CH₄ is conducted at a temperature of about 100-900° C., 200-800° C., 300-700° C., 400-600° C., 500-700° C., 600-850° C., 650-800° C., 700-900° C., 700-850° C., or 750-800° C. In certain embodiments, contacting CH₄ is conducted at a temperature of about 100, 200, 300, 400, 500, 550, 600, 650, 700, 750, 800, 850, or 900° C. In certain embodiments, contacting CH₄ is conducted at a temperature of about 700, 800, or 900° C.

In certain embodiments, the steps of a) contacting with CO₂ and b) contacting with CH₄ as described herein can be repeated for at least 2, 3, 4, 5, 6, 7, 8, 9, 10, 11, 12, 13, 14, 15, 20, 25, 30 or more cycles. In certain embodiments, the steps can be repeated for 10, 15, 20, 25, or 30 cycles. In certain embodiments, the steps can be repeated for 15, 30, or more cycles.

In certain embodiments, the presence of Ni-doped CaTiO₃ between CaO grains prevents CaO/CaCO₃ thermal sintering or CaO aggregation during ICCDRM cycles. In certain embodiments, after several cycles (e.g., 15 or 30 cycles), the CaO crystallite size is maintained, or increased by no more than 30%, 25%, 20%, or 15%. In certain embodiments, after several cycles (e.g., 15 or 30 cycles), the CaO crystallite size in the composition described herein has a size of about 23-33 nm, 24-32 nm, 25-31 nm, 26-30 nm, or 27-29 nm. In certain embodiments, after several cycles (e.g., 15 or 30 cycles), the CaO crystallite size in the composition described herein has a size that is less than 45 nm or 40 nm.

In certain embodiments, the strong interaction between CaTiO₃ and the socketed Ni prevents or reduces Ni sintering. In certain embodiments, after several cycles (e.g., 15 or 30 cycles), the NiO crystallite size is maintained, or increased by no more than 30%, 25%, 20%, or 15%.

In certain embodiments, after several cycles (e.g., 15 or 30 cycles), the CO₂ capture capability of the composition is reduced by no more than 50%, 45%, 40%, or 35%.

In certain embodiments, the strong interaction between CaTiO₃ and socketed Ni reduces coke deposition from CH₄ decomposition.

Certain embodiments of the invention provide a method of making a multifunctional composition described herein, comprising:
mixing Ni, Ca and Ti metal precursors (e.g., Ni, Ca metal salts, Ti metal alkoxide), a metal chelating agent (e.g., citric acid, EDTA), and a polymerization agent (e.g., a polyhydroxy alcohol or ether thereof, such as ethylene glycol or its ether) in an aqueous solution,
drying the aqueous solution (e.g., at about 100-120° C. for 6-18 hrs) to a dried gel, and
heating (e.g., at about 500-900° C., 600-850° C., or 700-900° C., such as 800° C.) the dried gel to produce the multifunctional composition.

In certain embodiments, the method further comprises grinding the dried gel (e.g., prior to heating at about 500-900° C.).

In certain embodiments, the method comprises mixing Ni(NO₃)₂, Ca(NO₃)₂, Ti(C₄H₉O)₄, citric acid, and ethylene glycol butyl ether in an aqueous solution.

In certain embodiments, the Ni to Ti molar ratio is about 1:99 to 3:97, 1:99 to 5:95, or 2:98 to 5:95. In certain embodiments, the Ni to Ti molar ratio is about 1:99, 2:98, 3:97, 4:96, or 5:95. In certain embodiments, the Ca to (Ni+Ti) molar ratio is about 2:1.

In certain embodiments, the molar ratio of chelating agent to metal ions is about 1. In certain embodiments, the molar ratio of chelating agent to polymerization agent is about 3.

In certain embodiments, the method further comprises contacting the multifunctional composition with H₂, for example, contacting the multifunctional composition with H₂/He (e.g., under heating at 800° C. for 1-3 hrs).

Certain exemplary embodiments are also provided as follows:

Embodiment 1. A composition or functional material (e.g., MFMs) described as herein.

Embodiment 2. A composition or CO₂ capture material, comprising calcium titanate (CaTiO₃), and Nickel (Ni), and a CO₂ sorbent material.

Embodiment 3. The composition or CO₂ capture material of Embodiment 2, wherein the sorbent material comprises CaO.

Embodiment 4. A composition or functional material, comprising:
a) CaTiO₃ perovskite and Ni, and
b) CaO and/or CaCO₃,
wherein Ni is attached to CaTiO₃ perovskite, and/or Ni is incorporated into CaTiO₃ perovskite to form a double perovskite CaNiₓTi₁₋ₓO₃.

Embodiment 5. The composition or functional material of Embodiment 4, wherein 0<x≤0.05.

Embodiment 6. The composition or functional material of Embodiment 5, wherein x is 0.02, or 0.05.

Embodiment 7. The composition or functional material of Embodiment 4, comprising Ni/CaTiO₃/CaO.

Embodiment 8. The composition or functional material of Embodiment 4, comprising CaNiₓTi₁₋ₓO₃/CaCO₃.

Embodiment 9. The composition or functional material of Embodiment 4, comprising NiO.

Embodiment 10. A nanocomposite material (e.g., MFMs) as described herein, comprising 1) Ni-doped CaTiO₃ and 2) CaO and/or CaCO₃, wherein Ni species is present as one or more form selected from the group consisting of Ni⁰, NiO, and Ca(NiₓTi₁₋ₓ)O₃.

Embodiment 11. A method of capturing and/or utilizing CO₂, comprising contacting a composition comprising Ni, CaTiO₃, and CaO as described herein with CO₂.

Embodiment 12. The method of Embodiment 11, wherein the composition comprising Ni, CaTiO₃, and CaO is converted to a composition comprising CaNiₓTi₁₋ₓO₃ and CaCO₃.

Embodiment 13. The method of Embodiment 12, further comprising contacting the composition comprising CaNiₓTi₁₋ₓO₃ and CaCO₃ with CH₄.

Embodiment 14. The method of Embodiment 13, wherein the composition comprising CaNiₓTi₁₋ₓO₃ and CaCO₃ is converted to the composition comprising Ni, CaTiO₃, and CaO.

The invention will now be illustrated by the following non-limiting Examples.

### Example 1. Self-Regenerative Ni-Doped CaTiO₃/CaO for Integrated CO₂ Capture and Dry Reforming of Methane.

In this Example, a new type of multifunctional materials (MFMs) called self-regenerative Ni-doped CaTiO₃/CaO is introduced for the integrated CO₂ capture and dry reforming of methane (ICCDRM). These exemplary materials comprise a catalytically active Ni-doped CaTiO₃ and a CO₂ sorbent, CaO. The Example proposes a concept where the Ni catalyst can be regenerated in situ, which is important for ICCDRM. Exsolved Ni nanoparticles are evenly distributed on the surface of CaTiO₃ under H₂ or CH₄, and are re-dispersed back into the CaTiO₃ lattice under CO₂. The Ni-doped CaTiO₃/CaO MFMs show stable CO₂ capture capacity and syngas productivity for 30 cycles of ICCDRM. The presence of CaTiO₃ between CaO grains prevents CaO/CaCO₃ thermal sintering during carbonation and decarbonation. Moreover, the strong interaction of CaTiO₃ with exsolved Ni mitigates severe accumulation of coke deposition. This concept can be useful for developing MFMs with improved properties that can advance integrated carbon capture and conversion.

### Introduction

Integrated CO₂ capture and utilization (ICCU) has been widely studied as a promising climate mitigation strategy for producing CO₂-derived fuels or chemicals such as methane, synthetic gas (syngas, CO, and H₂), light olefins, and methanol.^{[1]} ICCU is a less energy-intensive process compared to conventional CO₂ capture and utilization (CCU). Conventional CCU involves separating CO₂ from waste streams through carbonation (capture) and decarbonation (regeneration), transporting it via pipelines, and converting it into value-added chemicals.^{[2]} ICCU uses dual functional materials (DFMs), catalysts combined with CO₂ sorbents, to directly convert captured CO₂ into fuels and chemicals without separating and transporting CO₂.^{[3]} Ni/CaO-based dual functional materials (DFMs) are commonly used in ICCU processes due to the excellent catalytic activity of Ni and theoretical CO₂ capture capacity of CaO (17.8 mmol CO₂/g CaO) at temperatures ranging from 500 to 700° C., which are relevant for CO₂ valorization.^{[3], [4]} For example, Ni/CaO-based DFMs have been applied to various ICCU schemes such as methanation,^{[3], [4]} reverse water gas shift (rWGS),^{[4]} dry reforming of methane (DRM),^{[4]} and oxidative dehydrogenation of ethane to ethylene.^{[5]} Among the reactions studied, the Integrated CO₂ capture and subsequent DRM (ICCDRM) process using Ni/CaO-based DFMs is a promising strategy to convert two greenhouse gases, CO₂ and CH₄, into useful industrial building blocks—syngas.^{[4]}

The initial step for ICCDRM occurs when CO₂ is chemically absorbed from a waste stream by CaO to form CaCO₃ in the carbonation step, CaO(s)+CO₂(g)⇄CaCO₃(s). Then the desorbed CO₂ from CaCO₃ reacts with CH₄ to produce syngas via DRM over the adjacent Ni catalyst, CaCO₃(s)+CH₄(g)⇄CaO(s)+2CO(g)+2H₂(g).^{[4]} ICCDRM exhibits excellent decarbonation kinetics, CaCO₃(s)⇄CaO(s)+CO₂(g), by shifting the equilibrium toward the products (Le Chatelier's principle) because of continuous consumption of CO₂ by DRM; CO₂(g)+CH₄(g)=2CO(g)+2H₂(g).^{[4]} However, ICCDRM does not have sufficient multicycle performance for industrial practicality due to a sharp decrease in syngas production after complete CO₂ desorption and coke deposition from CH₄ decomposition: CH₄(g)⇄C(s)+2H₂(g).^{[4]}

Coke deposition is one of the primary deactivation mechanisms for Ni catalysts used for DRM and ICCDRM. The coke can be deposited easily over large Ni nanoparticles (>20 nm) with inherently weak interaction with the underlying support.^{[6]} Some of the deposited coke can be gasified via the reverse Boudouard reaction, C(s)+CO₂(g)=2CO(g); however, the remaining coke can result in a gradual decrease in the CO₂ capture capacity and catalyst performance.^{[4]} The coke deposition can form metal carbides that decompose into carbon and metal atoms or clusters.^{[7]} Continuous carbon accumulation can cause filamentous or whisker coke to separate active Ni metal nanoparticles from the support.^{[7]} Filamentous coke is difficult to oxidize or remove because the interface between the metal nanoparticles and support is thermodynamically-stable.^{[8]} Therefore, enhancing the interaction between Ni and oxide supports/sorbents is important to maintain catalytic performance and stability.

Another factor that diminishes the multicycle performance of Ni/CaO-based materials for ICCDRM is the low thermal stability of CaO. The stress induced by the cyclical volume expansion and shrinkage from CaO to CaCO₃ (CaO: 16.9 cm³ g⁻¹ and CaCO₃: 36.9 cm³ g⁻¹) during carbonation and decarbonation^{[9]} can contribute to rapid pore collapse of the structure. Additionally, the lower Tammann temperature of CaCO₃ (533° C.) than the DRM operation temperature (≈700° C.) causes the loss of surface area and sintering-induced decrease in CO₂ capture capacity.^{[9], [10]} During each cycle, the reversible phase transformation of CaO to CaCO₃ weakens the Ni-CaO metal support interaction, resulting in significant sintering of Ni nanoparticles.^{[11]}

The use of in-situ exsolved metal nanoparticles from a select family of reducible perovskite oxides (ABO₃) has been utilized to address issues such as coking and sintering in DRM reaction conditions.^{[12]} The perovskite oxide structure (ABO₃) comprises a large A-site cation (La, Nd, Ca, Sr, or Ba) and a smaller B-site cation (Ti, Fe, Co, or Ni) where catalytic metals are substituted.^{[12], [13]} There are many benefits to using exsolution to generate catalyst nanoparticles. For instance, the nanoparticles formed are homogeneously distributed throughout the support.^{[14]} The inherent strong interaction between the partially submerged (or socketed) exsolved metal nanoparticles and host perovskites may retard the thermal sintering of metal nanoparticles.^{[15]} The exsolved metal nanoparticles can undergo self-regeneration by re-incorporating into the host perovskite under oxidative conditions and then re-exsolving under reductive conditions. The self-regeneration mechanism may also suppress coke accumulation during redox experiments by in situ gasification to COₓ by surface lattice oxygen of the perovskite oxide.^{[12], [16]} The partially submerged or socked nanoparticles may also suppress filamentous coke growth between the metal nanoparticles and perovskite support.^{[17]}

The morphology of CaO plays an essential role in the CO₂ capture kinetics, CO₂ uptake capacity, and thermal stability.^{[9], [18]} To improve the sinter-resistance behavior of CaO, inert metal oxide stabilizers with high Tammann temperatures, such as ZrO₂, SiO₂, Al₂O₃, CeO₂, or MgO, are introduced into the CaO structure. The CaO/CaCO₃ stabilization with oxide additives can improve CO₂ capture performance (kinetics and capacity) by enhancing CO₂ diffusion within the porous structure and preventing the densification of the CaO particles.^{[9]} In addition, inert oxide materials between CaO crystallite grains can minimize CaCO₃ volume expansion during the CO₂ capture step, alleviating the stress-induced sintering of CaO.^{[9]}

To make ICCDRM commercially viable, addressing issues such as enhancing CO₂ uptake capacity, sintering of CaO and Ni, and coke deposition is vital. This study discusses an exciting approach to improve ICCDRM multicycle stability by developing self-regenerative Ni/CaTiO₃/CaO multifunctional materials (MFMs). The Ni nanoparticles are exsolved from Ca(NiₓTi₁₋ₓ)O₃ perovskite oxide. The strong adherence of exsolved Ni nanoparticles to Ca(NiₓTi₁₋ₓ)O₃ perovskite decreases the Ni sintering rate and coke formation, allowing for long-term multicycle catalytic stability. The strong metal-support interaction between Ni and CaTiO₃ suppresses the growth of filamentous coke. Coke formed on the surface of Ni nanoparticles during the DRM step is gasified by CO₂ during carbonation. The Ni nanoparticles are also self-regenerated during the CO₂ capture step (oxidative conditions) and re-emerged during the subsequent DRM (reductive conditions). The presence of CaTiO₃ perovskite phase within CaO grains alleviates the thermal sintering of CaO/CaCO₃ phases. The Ni/CaTiO₃/CaO MFMs were characterized for their CO₂ capture capacity and ICCDRM performance. The experiments were developed to elucidate the property function relation for Ni/CaTiO₃/CaO MFMs.

### Results and Discussion

### 2.1 Structural, Morphological, and Textural Properties of Ni-Doped CaTiO₃/CaO MFMs

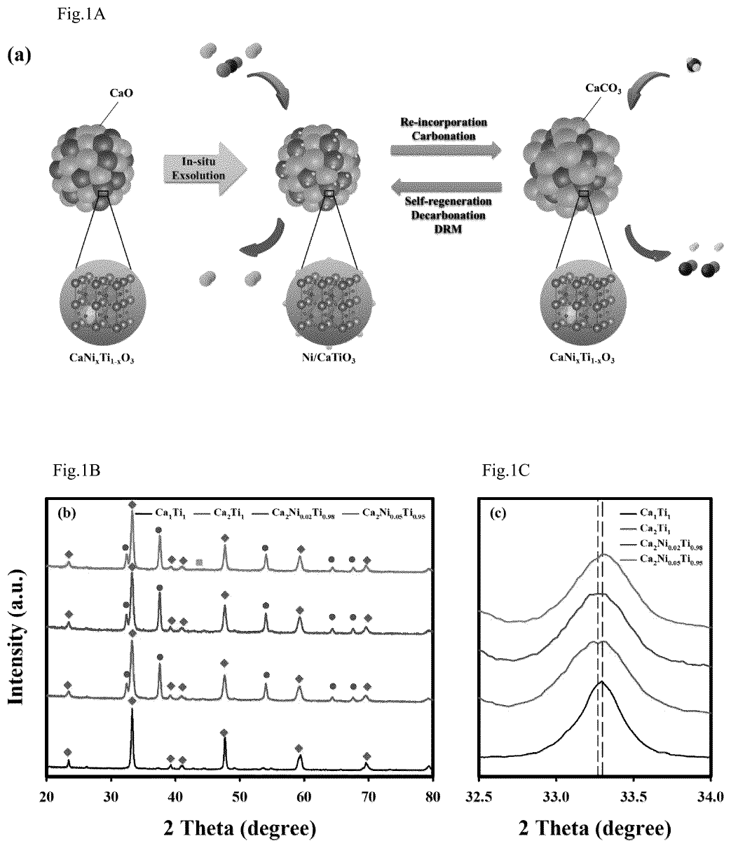

FIG. 1A illustrates the schematic of Ni incorporation into the CaTiO₃ perovskite frameworks during calcination and in-situ Ni exsolution from Ca₁₊ₓNi_{y}Ti_{1-y}O₃ perovskite during the ICCDRM process. For this study, Ca₁₊ₓNi_{y}Ti_{1-y}O₃ perovskite materials with secondary phase of CaO were calcined at 800° C. to incorporate Ni into CaTiO₃ and avoid the formation of perovskite-like structures containing higher Ca/Ti ratios, such as Ca₃Ti₂O₇ and Ca₄Ti₃O₁₀, which form at higher temperatures above 1000° C. and are nonreducible materials. The emergence of Ni occurs under a reductive environment (i.e., H₂) at 800° C. During the CO₂ capture step, the Ni nanoparticles are re-incorporated into the perovskite Ca₁₊ₓNi_{y}Ti_{1-y}O₃ matrix and CaO capture CO₂ as a formation of CaCO₃. Then the Ni nanoparticles are exsolved (e.g., self-regeneration of Ni nanoparticles), CO₂ desorbed from CaCO₃ reacts with CH₄ to produce syngas (CO and H₂) during the DRM step.

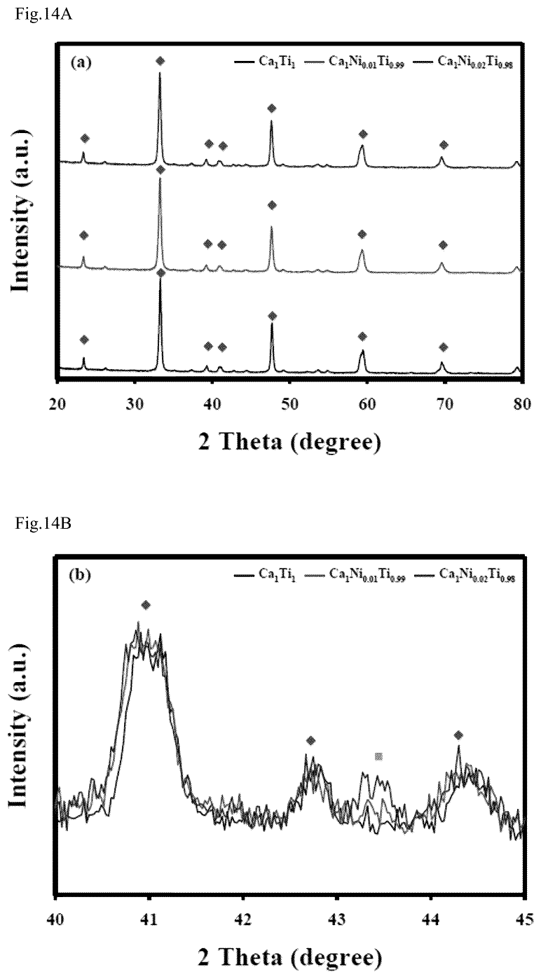

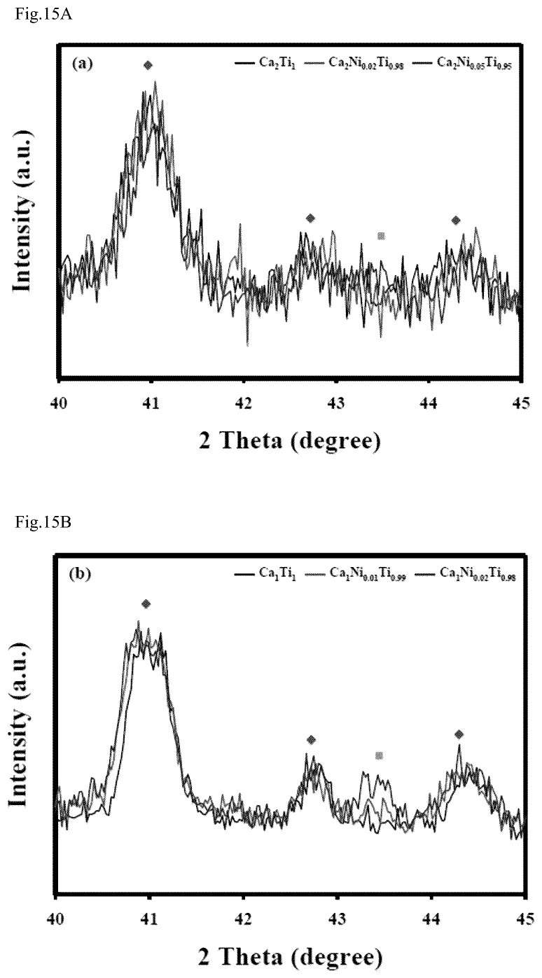

The X-ray diffraction (XRD) patterns of Ca₁Ti₁, Ca₂Ti₁, Ca₂Ni_{0.02}Ti_{0.98}, and Ca₂Ni_{0.05}Ti_{0.95} were compared to investigate the crystalline structure of the synthesized MFMs (FIGS. 1B-1C). For comparison, the XRD pattern of Ca₂Ni_{0.05} DFM was also measured (FIG. 13). As-prepared Ca₂Ni_{0.05} DFM showed sharp peaks of CaO (JCPDS No. 75-0264) and broad NiO (JCPDS No. 73-1519) without any CaNi alloy phases. After reduction at 800° C., NiO was converted to Ni metal (JCPDS No. 45-1027). The Ca₂Ni_{0.02}Ti_{0.98} and Ca₂Ni_{0.05}Ti_{0.95} MFMs were synthesized with excess Ca to promote the formation of CaO/CaTiO₃ composite materials. The concentration of Ni was changed to determine the influence on the catalytic performance and regeneration capability. Empirically, when the tolerance factor (t) lies in the range of 0.8-1.0, the structure of perovskites is stable. Although the tolerance factor is a good predictor of the perovskite stability, the octahedron factor (μ), a constant used to predict lattice distortion, must lie in the range of 0.44-0.72 for B and O to form a stable BO₆ octahedron. The tolerance factor (t) and octahedron factor (μ) of CaTiO₃ are 0.97 and 0.45, respectively, indicating that a stable CaTiO₃ perovskite structure is expected. On the other hand, the tolerance factor (t) and the octahedron factor (μ) of CaNiO₃ are 1.01 and 0.39, respectively, meaning that NiO₆ octahedron would be unstable to form CaNiO₃ perovskite structures. The XRD patterns of Ca₁Ti₁ exhibited sharp peaks of orthorhombic CaTiO₃ perovskite phase (JCPDS No. 86-1393) without impurity. The prominent peaks located at 33.1, 47.5, and 59.4 2theta correspond to the (1 1 2), (2 2 0), and (2 0 4) lattice planes of the CaTiO₃ structure. The XRD patterns of Ca₁Ti₁, Ca₁Ni_{0.01}Ti_{0.99}, and Ca₁Ni_{0.02}Ti_{0.98} showed the sharp peaks of CaTiO₃ perovskite phase without a separate CaO phase (FIG. 14A). Although a small amount of Ni is added, the patterns of NiO peak was observed in MFMs with a Ca-to-(Ni+Ti) ratio of 1, such as Ca₁Ni_{0.01}Ti_{0.99} and Ca₂Ni_{0.02}Ti_{0.98} (FIG. 14B and Table S1), which corresponds to the estimation from the predicted tolerance and octahedron factor for CaNiO₃. For Ca₂Ti₁, Ca₂Ni_{0.02}Ti_{0.98}, and Ca₂Ni_{0.05}Ti_{0.95}, it was observed that CaTiO₃ perovskite and CaO formed instead of the Ca₃Ti₂O₇ and Ca₄Ti₃O₁₀ phase. For Ca₂Ni_{0.05}Ti_{0.95} MFM, a small NiO peak was observed. However, the peak of NiO was not observed in the Ca₂Ni_{0.02}Ti_{0.98} MFM, showing a maximum solubility capacity for Ni dopants in the CaTiO₃ lattice (FIG. 15A). Estimated Ca/(Ni+Ti) ratio in perovskite obtained from STEM-EDS of as-prepared Ca₁Ni_{0.01}Ti_{0.99}, Ca₂Ni_{0.02}Ti_{0.98}, and Ca₂Ni_{0.05}Ti_{0.95} are 1.01, 1.01 and 1.09, respectively (Table S1). All samples showed Ca/(Ni+Ti) higher than 1, excess Ca and Ni exists as CaO and NiO, respectively. All Ni species were incorporated into CaTiO₃ perovskite frameworks in Ca₂Ni_{0.02}Ti_{0.98} MFM as a formation of Ca₁₊ₓNi_{y}Ti_{1-y}O₃/(1−x)CaO without NiO separation. After reduction at 800° C., a very small peak of Ni metal was observed in both Ca₂Ni_{0.02}Ti_{0.98} and Ca₂Ni_{0.05}Ti_{0.95} MFMs (FIG. 15B). Therefore, excess calcium promotes the formation of Ca₁₊ₓNi_{y}Ti_{1-y}O₃ perovskite with CaO despite the unstable NiO₆ octahedron.

TABLE S1
Perovskite formular obtained from the STEM-EDS of as-prepared
Ca₁Ni_{0.01}Ti_{0.99}, Ca₂Ni_{0.02}Ti_{0.98}, and Ca₂Ni_{0.05}Ti_{0.95}.

| | Element (Atomic %) | | | | |
|---|---|---|---|---|---|
| | | | | Ca/ | |
| | Ca | Ni | Ti | (Ni + Ti) | Formular |
| Ca₁Ni_{0.01}Ti_{0.99} | 50.33 | 0.38 | 49.29 | 1.01 | xNiO/ |
| | | | | | yCa₁Ni_{0.01}Ti_{0.98}O₃ |
| Ca₂Ni_{0.02}Ti_{0.98} | 50.32 | 0.82 | 48.86 | 1.01 | yCa_{1.01}Ni_{0.01}Ti_{0.98}O₃/ |
| | | | | | zCaO |
| Ca₂Ni_{0.05}Ti_{0.95} | 52.26 | 1.26 | 46.48 | 1.09 | xNiO/ |
| | | | | | yCa_{1.09}Ni_{0.03}Ti_{0.97}O₃/ |
| | | | | | zCaO |

FIG. 1C shows XRD patterns between 32.5 to 34° 2theta. The peak of CaTiO₃ perovskite shifts to lower angles from 33.3° (Ca₁Ti₁) to 33.27° (Ca₂Ti), indicating volume expansion as the ratio of Ca/Ti increases. According to the Rietveld refinement in Table 1, the lattice parameters of a, b, and c of CaTiO₃ for Ca₁Ti₁ are 5.443, 7.648, and 5.389 Å, respectively. The lattice parameters of a, b, and c for Ca₂Ti₁ are 5.457, 7.658, and 5.402, respectively, which are slightly larger than those of Ca₁Ti₁, leading to volume expansion from 224.32 to 225.76 Å³. Conversely, the diffraction peaks corresponding to CaTiO₃ shifted to a higher angle as the Ni/Ti ratio increased, implying lattice shrinkage owing to the substitution of Ti with Ni.^{[21]} It was also observed that the lattice parameters of a, b, and c of Ca₂Ni_{0.02}Ti_{0.98} and Ca₂Ni_{0.05}Ti_{0.95} MFMs are smaller than those of Ca₂Ti, and the lattice volume decreased.

TABLE 1
Refined cell parameters of Ca₁Ti₁, Ca₂Ti₁, Ca₂Ni_{0.02}Ti_{0.98}, and
Ca₂Ni_{0.95}Ti_{0.95} from XRD patterns.

| | Quantity | | | | |
|---|---|---|---|---|---|
| | (%) | Lattice parameters (Å) | | | Lattice |
| | CaTiO₃/CaO | a | b | c | volume (Å) |
| Ca₁Ti₁ | 100/— | 5.442 | 7.655 | 5.387 | 224.078 |
| Ca₂Ti₁ | 74/26 | 5.457 | 7.658 | 5.402 | 225.761 |
| Ca₂Ni_{0.02}Ti_{0.98} | 70/30 | 5.446 | 7.647 | 5.395 | 224.655 |
| Ca₂Ni_{0.05}Ti_{0.95} | 69/31 | 5.445 | 7.650 | 5.399 | 224.881 |

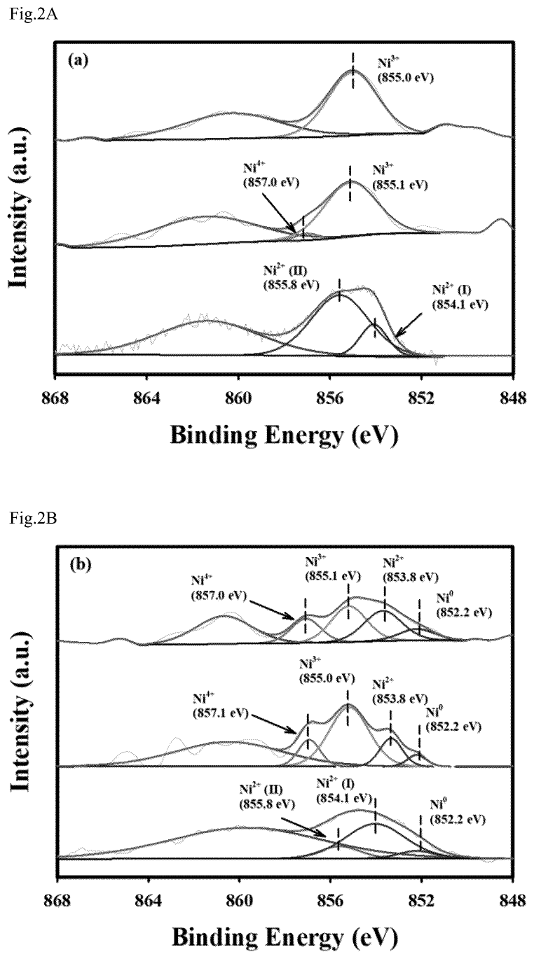

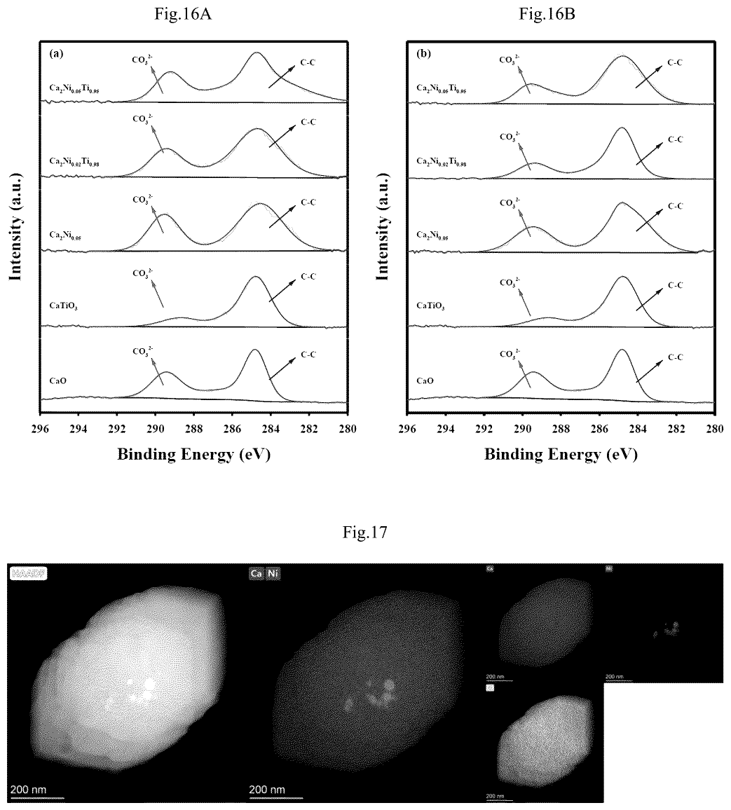

X-ray photoelectron spectroscopy (XPS) analysis was conducted for as prepared and reduced Ca₂Ni_{0.05}, Ca₂Ni_{0.02}Ti_{0.98} and Ca₂Ni_{0.05}Ti_{0.95}. The C—C component peak at 284.8 eV was used to calibrate the XPS raw data (FIG. 16). In the C 1s XPS spectra of all samples, adventitious C—C peak at 284.8 eV and CO₃²⁻ peak at ≈289 eV were observed.^{[22]} In the sample containing CaO, strong basic site, XPS spectra of CO₃²⁻ peak was high, which might be the CO₂ adsorption in the XPS chamber. In the Ni 2p_{3/2} XPS spectrum of Ca2Ni0.05 DFM, an asymmetric doublet peak of NiO was revealed by the Gaussian-Lorentzian curve fitting, with the peaks located at 8541.1 and 855.8 eV, and a broad satellite peak at higher binding energy at ≈861 eV (FIG. 2). The peak centered at 854.1 eV is attributed to the surface bulk NiO, Ni²⁺(I), whereas the peak at 855.6 eV is related to the NiO interacting with CaO, Ni²⁺(II).^{[4], [24]} In literatures, the Ni²⁺(I)/Ni²⁺(II) ratio decreased with an increase in Ca-to-Ni molar ratio in Ni/CaO DFMs.^{[4]} For Ca₂Ni_{0.02}Ti_{0.98} and Ca₂Ni_{0.05}Ti_{0.95}MFMs, two different peaks at 857.2 eV and 855.1 eV are attributed to Ni⁴⁺ and Ni³⁺ species, respectively, whereas bulk NiO, Ni²⁺ (I), peak was not observed.^{[25]} Although Ni 2p spectra were unclear because of low Ni amount in the samples, metallic Ni peak at 852.2 eV was observed in all samples after reduction. The Ni⁴⁺ and Ni³⁺ peaks decreased and Ni2⁺ (853.6 eV) and Ni⁰ (852.4 eV) peaks appeared. The existence of Ni⁴⁺ and Ni³⁺ species implies that not all Ni species were exsolved from the host Ca₁₊ₓNi_{y}Ti_{1-y}O₃ perovskite. The detection of Ni²⁺ species implies that Ni⁰ on the surface might be oxidized before measuring XPS results in the chamber.^{[23]}

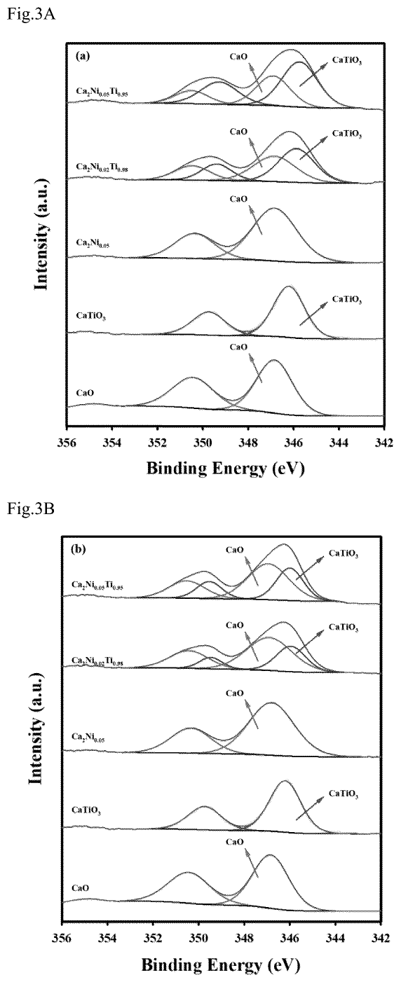

In the Ca 2p XPS spectra of CaO and Ca₂Ni_{0.05} DFM, Ca 2p_{3/2} (350.4 eV) and Ca2p_{1/2}(346.9 eV) doublet were observed with a separation of 3.5 eV and intensity ratio of 1/2,^{[26]} and binding energy values remained constant after reduction (FIG. 3). For Ca₂Ni_{0.02}Ti_{0.98} and Ca₂Ni_{0.05}Ti_{0.95} MFMs, Ca 2p spectra was deconvoluted into two CaO peaks (350.4 and 346.9 eV) and two CaTiO₃ peaks (349.4 and 345.9 eV).^{[27]} After reduction, an increase in the ratio of CaO to CaTiO₃ was observed, resulting from the Ni and CaO exsolution from the host Ca₁₊ₓNi_{y}Ti_{1-y}O₃ perovskite.

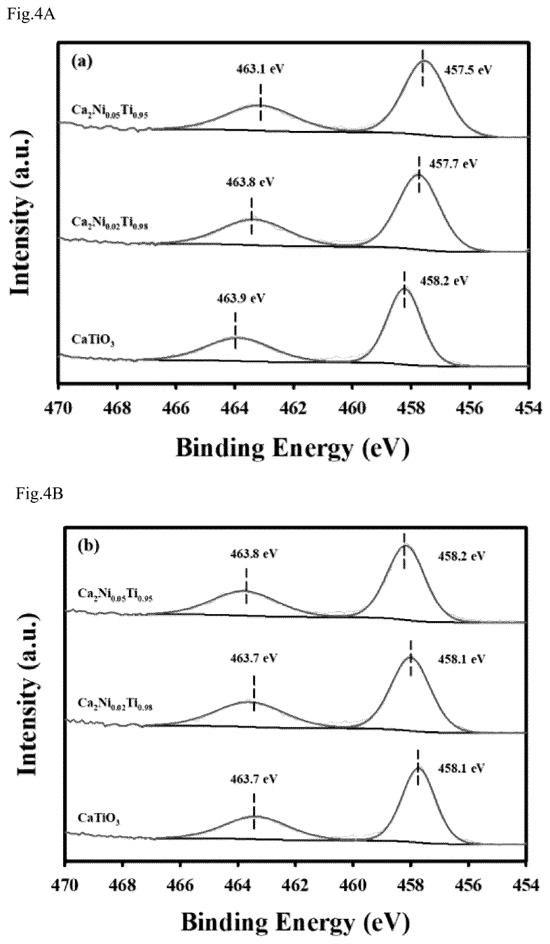

For Ti 2p XPS spectrum of CaTiO₃, two main distinct peaks were observed at 463.9 and 458.2 eV (FIG. 4).^{[27]} It is clearly seen that the Ti 2p XPS spectra of Ca₂Ni_{0.02}Ti_{0.98} and Ca₂Ni_{0.05}Ti_{0.95} MFMs shifted to lower binding energy after Ni incorporation, and the spectra further shifted with increasing Ni-to-Ti ratio. After reduction, the binding energy values of the MFMs are comparable to that of bare CaTiO₃ perovskite, implying Ni exsolution from the Ca₁₊ₓNi_{y}Ti_{1-y}O₃.

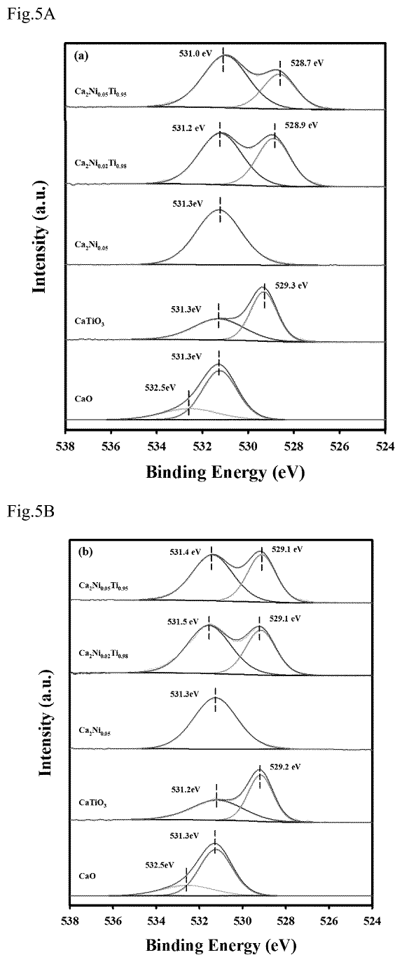

The XPS spectra for O 1s profiles is broad and complicated due to the overlapping peaks of oxygen in lattice of NiO, CaO and CaTiO₃, oxygen defect (oxygen vacancies) and adsorbed oxygen (FIG. 5). The O 1s XPS spectrum of CaO contained main peaks located at 531.3 with minor at 532.5 eV, corresponding to lattice oxygen of CaO and adsorbed water or surface hydroxyls on CaO.^{[28]} In the O 1s XPS spectrum of CaTiO₃, two peaks were deconvoluted at 531.3 and 529.3 eV, which are attributed to adsorbed oxygen in CaTiO₃ and lattice oxygen, respectively. For Ca₂Ni_{0.05} DFM, two peaks for lattice oxygen of NiO and CaO overlapped at ≈531.5 eV, and the peak intensity decreased slightly after reduction, which might be reduction of NiO. Compared to CaTiO₃, a higher peak at ≈531.2 eV was observed in Ca₂Ni_{0.02}Ti_{0.98} and Ca₂Ni_{0.05}Ti_{0.95} MFMs, because of CaO existence. The binding energy of two peaks decreased with increasing Ni ratio. The binding energy values increased after reduction, which are comparable to the spectra of CaO and CaTiO₃. In addition, the ratio of peak (≈531.4 eV)-to-peak (529.1 eV) decreased in the Ca₂Ni_{0.05}Ti_{0.95} MFM after reduction, which might be reduction of NiO on the surface. Based on the XRD and XPS results, it is clearly observed that the incorporated Ni species can be exsolved from the Ca₁₊ₓNi_{y}Ti_{1-y}O₃ perovskite.

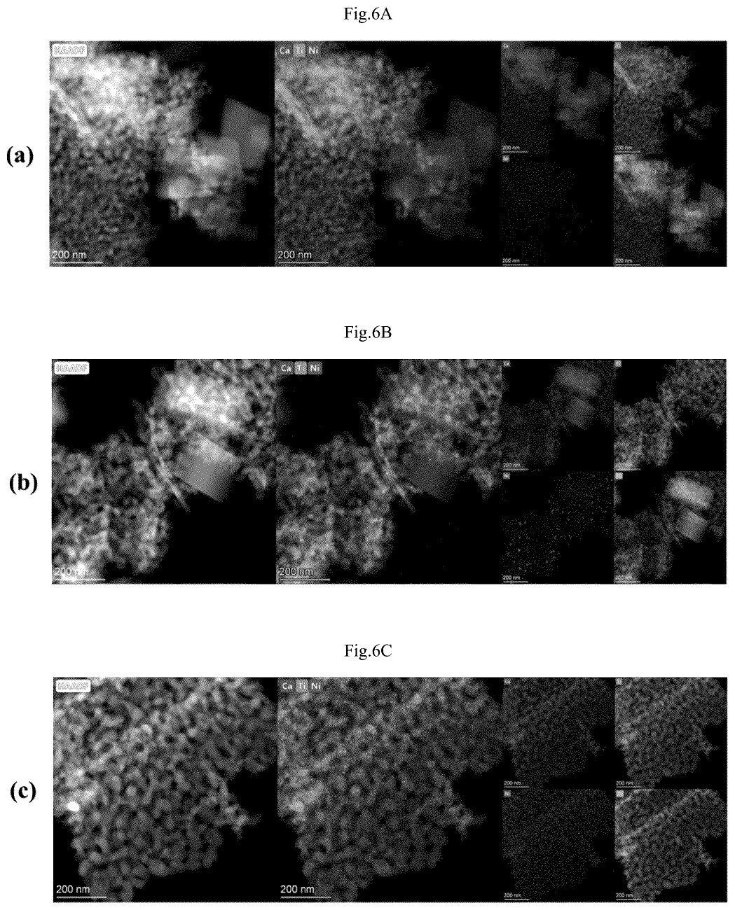

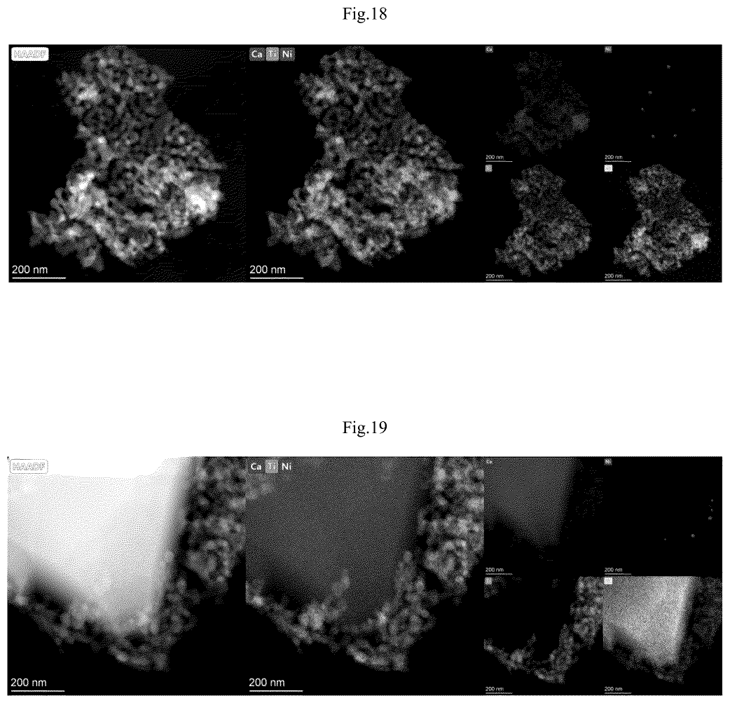

To investigate the self-regeneration properties of Ni (in-situ Ni exsolution from Ca₁₊ₓNi_{y}Ti_{1-y}O₃ and Ni re-dissolving to CaTiO₃ perovskite) under the ICCDRM conditions, Scanning Transmission Electron Microscopy (STEM) High-angle annular dark field imaging (HAADF) experiments with energy-dispersive spectroscopy (EDS) were conducted. Ca₂Ni_{0.02}Ti_{0.98} MFM was selected to observe the self-regeneration of Ni nanoparticles, as no excess NiO species were present on the CaTiO₃ surface in the as-prepared state. The STEM EDS-mapping images of as-prepared Ca₂Ni_{0.02}Ti_{0.98} MFM, cubic/cuboid CaO, and Ca₁₊ₓNi_{y}Ti_{1-y}O₃ perovskite are strongly coupled (FIG. 6A). Ni species on the surface of the material were not observed in the as-prepared Ca₂Ni_{0.02}Ti_{0.98} MFM. STEM-EDS images of Ca₂Ni_{0.05} DFM were also measured, and NiO nanoparticles with crystallite size of ≈25 nm were unevenly dispersed on the cubic CaO in the STEM EDS-mapping of Ca₂Ni_{0.05} DFM (FIG. 17). In FIG. 18, Ni nanoparticles (i.e., NiO) with an average crystallite size of ≈25 nm were observed in Ca₂Ni_{0.05}Ti_{0.95} MFM (FIG. 18), corresponding to the XRD and XPS results. Although not all Ni nanoparticles are incorporated into CaTiO₃ (i.e., Ca₁₊ₓNi_{y}Ti_{1-y}O₃), they are supported on CaTiO₃ perovskite, which might result in a stronger interaction between Ni and CaTiO₃ than that between Ni and CaO.

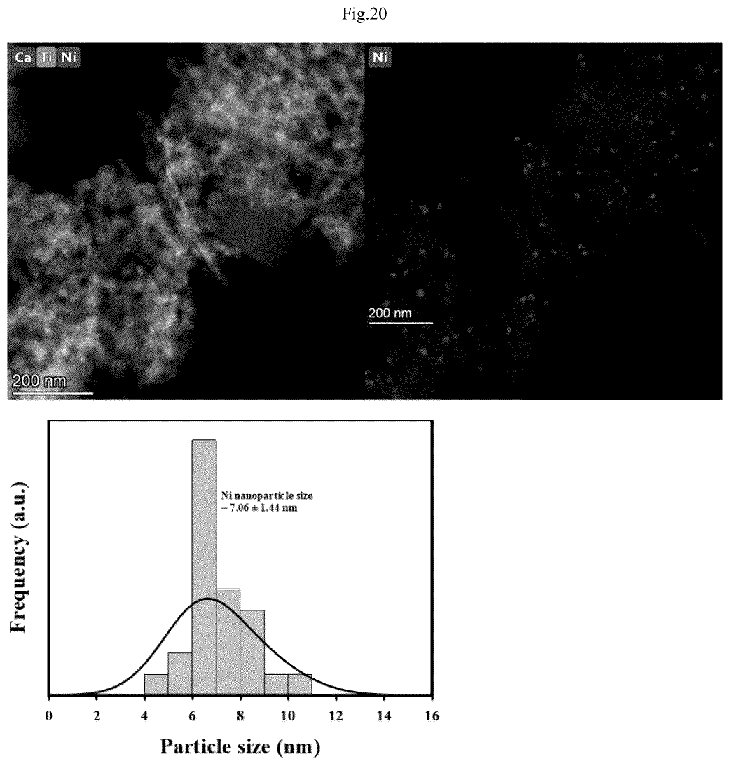

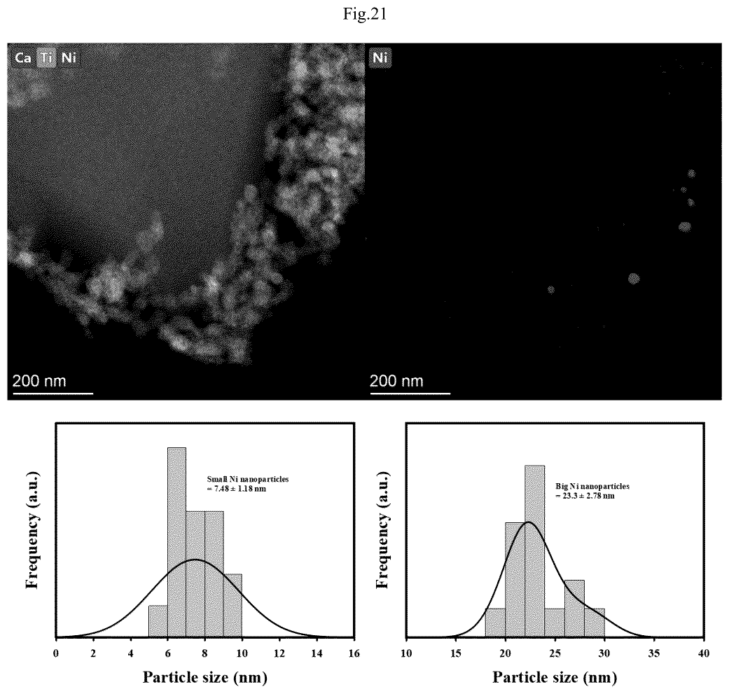

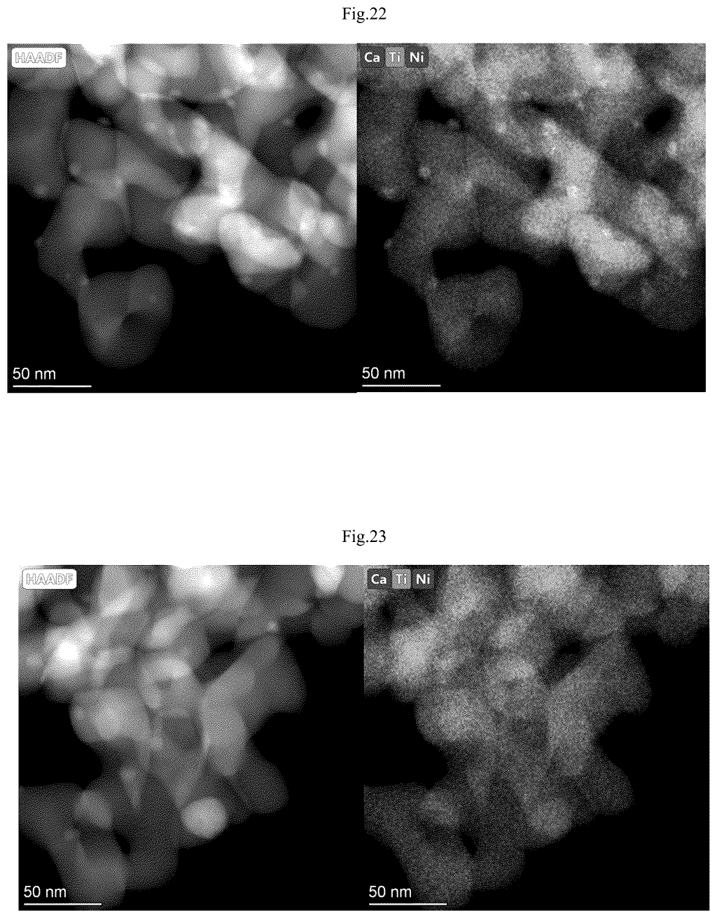

After H₂-reduction at 800° C. for 1 h, in situ exsolved Ni nanoparticles were distributed evenly on the surface of CaTiO₃ support (FIG. 6B). The Ni nanoparticle size distribution was obtained from the STEM mapping of Ca₂Ni_{0.02}Ti_{0.98} and Ca₂Ni_{0.05}Ti_{0.95} MFMs (FIG. 20 and FIG. 21). It is observed in the STEM-HAADF images of Ca₂Ni_{0.02}Ti_{0.98}MFMs that the Ni nanoparticles are exsolved from Ca₁₊ₓNi_{y}Ti_{1-y}O₃ host perovskite (FIG. 19). For Ca₂Ni_{0.05}Ti_{0.95} MFM, a minority of larger Ni nanoparticles (≈23 nm) were observed, as corroborated by XRD, which coexisted with the in-situ exsolved Ni nanoparticles. The average crystallite size of exsolved Ni nanoparticles in Ca₂Ni_{0.02}Ti_{0.98} and Ca₂Ni_{0.05}Ti_{0.95} were 7.06 and 7.48 nm, respectively (FIG. 20 and FIG. 21). In the STEM-HAADF image, it is clearly observed that the exsolved Ni nanoparticles were socketed in the host perovskite (FIG. 22 and FIG. 23). It is expected that the in-situ exsolved Ni nanoparticles formed from bulk-to-surface diffusion have a stronger interaction with CaTiO₃ and smaller crystallite size than the Ni nanoparticles deposited on the surface of CaTiO₃.

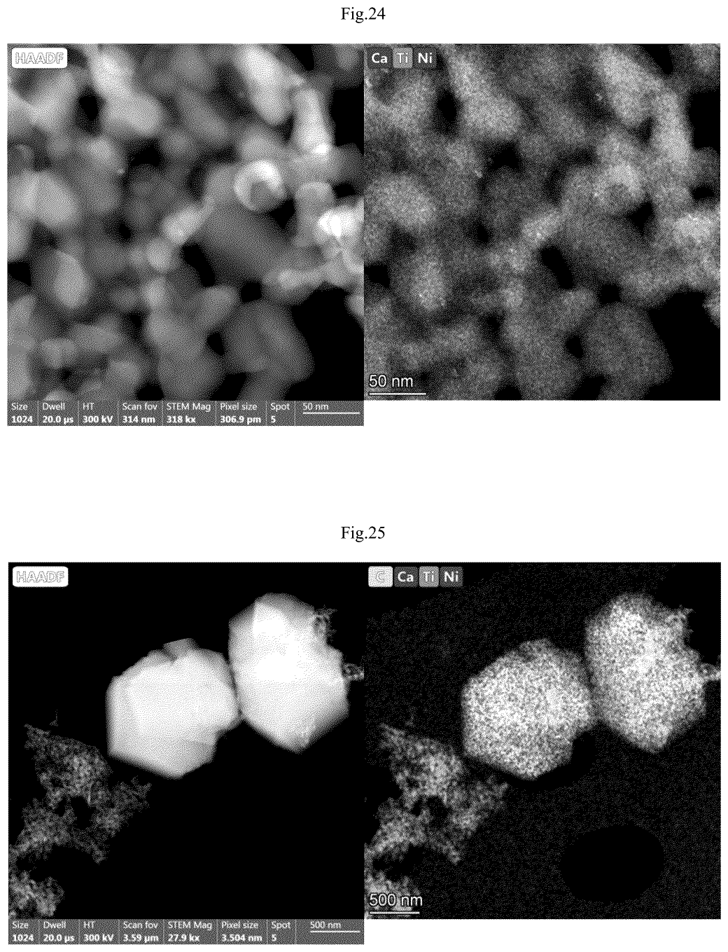

The reduced Ca₂Ni_{0.02}Ti_{0.98} MFM was re-oxidized under CO₂ capture condition (10% CO₂/He condition at 700° C. for 1 h) to investigate the morphology change of exsolved Ni nanoparticles and the composite materials. In the STEM image of Ca₂Ni_{0.02}Ti_{0.98} MFM after re-oxidation with CO₂, the exsolved Ni nanoparticles were dispersed throughout the CaTiO₃ and re-incorporated into the subsurface of CaTiO₃ perovskite (FIG. 6C; FIG. 24). Some Ni nanoparticles socketed in the CaTiO₃ perovskite still exist, however, the crystallite size of Ni nanoparticles is much smaller than the exsolved Ni nanoparticles (FIG. 6B). The regeneration of larger Ni nanoparticles could have been hindered by the kinetics of re-dissolution, which is an important parameter for predicting the regeneration of exsolved nanoparticles. In addition, CO₂ was chemically absorbed on the CaO grains as a formation of CaCO₃ (FIG. 25). It is expected that the volume expansion of CaCO₃ grains by CO₂ capture would not affect Ni exsolution at the subsequent DRM step, because CaCO₃ grains were separated from the host Ca₁₊ₓNi_{y}Ti_{1-y}O₃ perovskite.

### 2.2 Enhanced Ni—CaTiO₃ Metal-Support Interaction

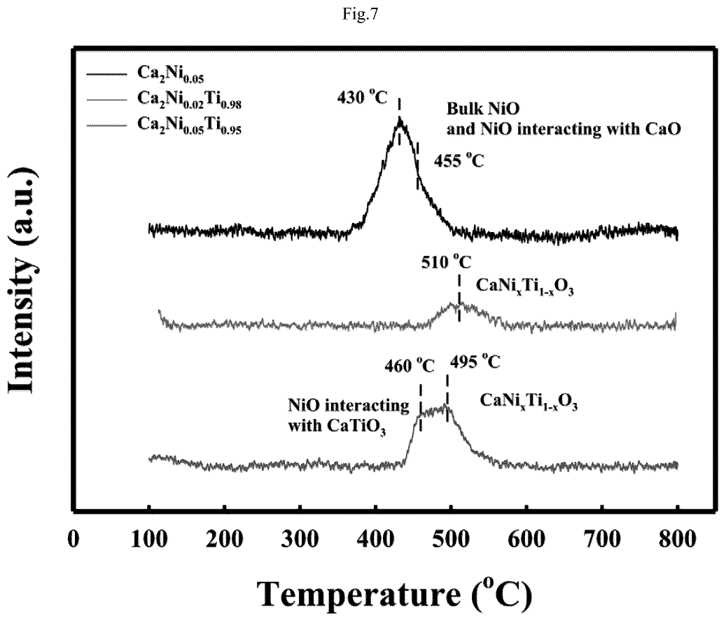

FIG. 7 shows H₂-Temperature programmed reduction (H₂-TPR) results of Ca₂Ni_{0.05}, Ca₂Ni_{0.02}Ti_{0.98} and Ca₂Ni_{0.05}Ti_{0.95} from 100 to 800° C. with temperature ramping of 10 C min⁻¹, to investigate metal-support interaction. All samples were pretreated under 20% O₂/He at 800° C. for 1 h, to desorb adsorbed gases such as CO₂ and H₂O and to avoid lattice oxygen loss of perovskite. Ca₂Ni_{0.05} shows a sharp peak centered at 430° C. with shoulder at 455° C., which are attributed to overlapped reduction peak of bulk NiO and NiO interacting with CaO, respectively.^{[4]} Ca₂Ni_{0.02}Ti_{0.98} MFM shows one broad peak corresponding to Ca₁₊ₓNi_{y}Ti_{1-y}O₃ reduction at 450 to 550° C., which is higher than the reduction of bulk NiO. The reduction peak of bulk NiO was not observed, which is consistent with XRD result. Ca₂Ni_{0.05}Ti_{0.95} MFM exhibited two overlapping peaks at 460 and 500° C., respectively. The first reduction peak is ascribed to the reduction of NiO interacting with CaTiO₃ at 460° C. The onset temperature of the first peak is 430° C., which is higher than that of the reduction peak of bulk NiO (360° C.) in the Ca₂Ni_{0.05} DFM, implying that NiO interaction with CaTiO₃ is slightly stronger than that with CaO. The second reduction peak at 495° C. is attributed to the reduction of Ca₁₊ₓNi_{y}Ti_{1-y}O₃ reduction, which is lower slightly than that in the Ca₂Ni_{0.02}Ti_{0.98}MFM.

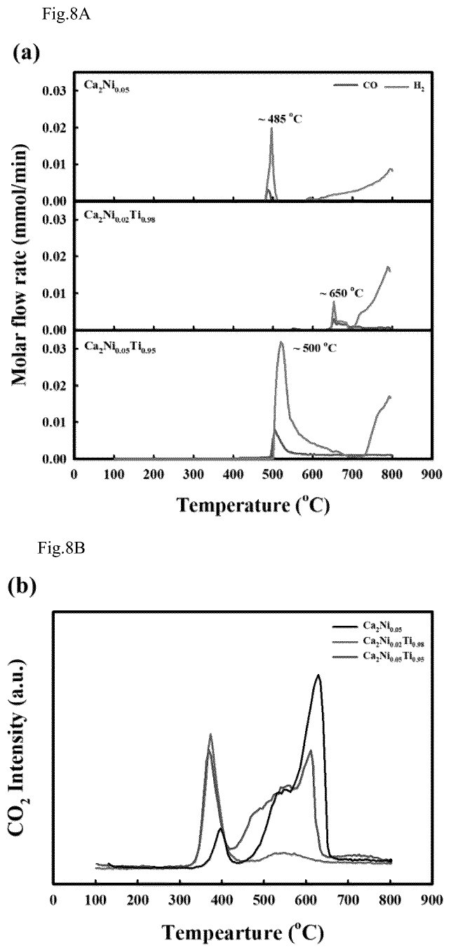

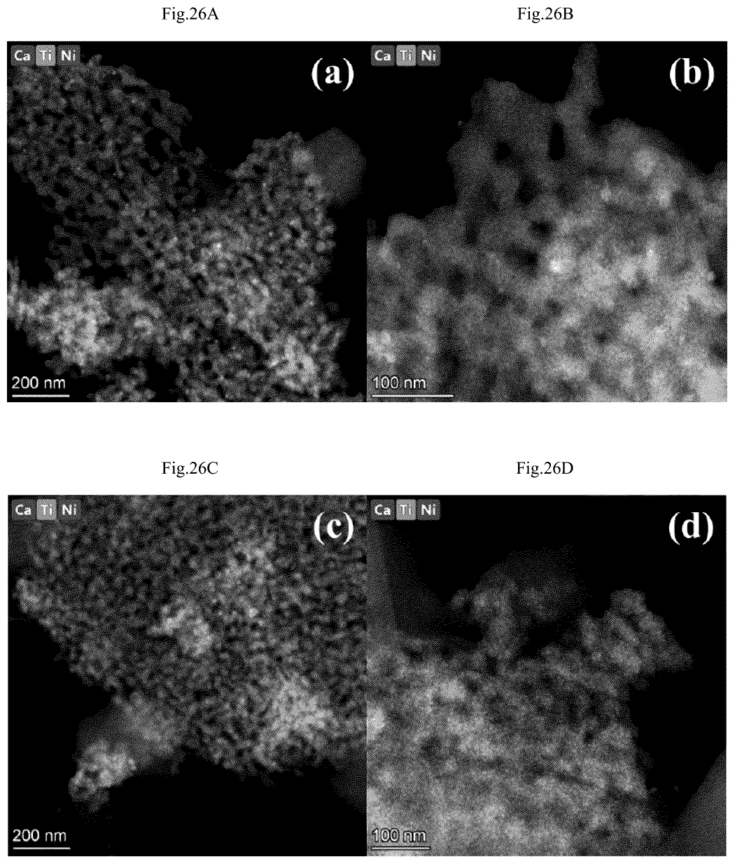

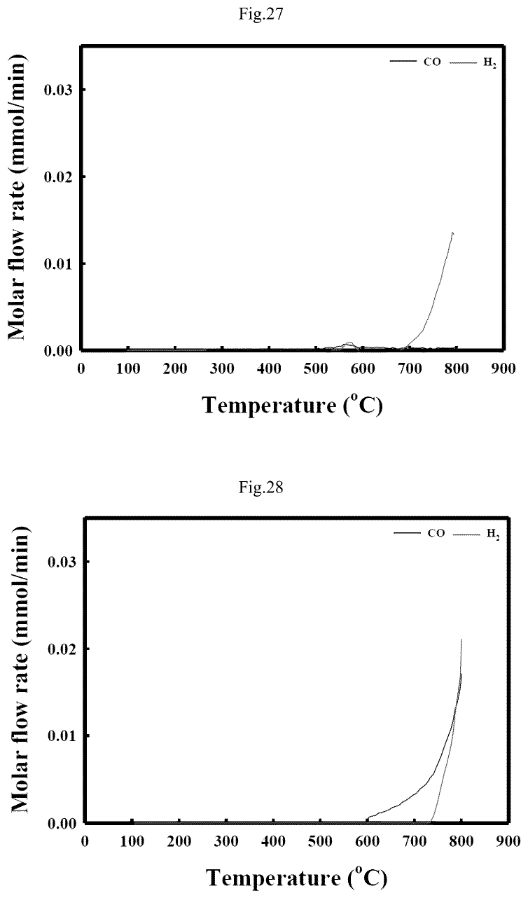

To investigate the metal support interaction between Ni nanoparticles socketed in CaTiO₃ and reaction performance over reduced Ni under CH₄ condition, CH₄-TPR tests of Ca₂Ni_{0.05}, Ca₂Ni_{0.02}Ti_{0.98}, and Ca₂Ni_{0.05}Ti_{0.95} were conducted in the presence of 10 vol % CH₄ from 100 to 800° C. with temperature ramping of 10° C. min⁻¹ (FIG. 8A). All samples were pretreated under 20 vol % O₂/He at 800° C. for 1 h to desorb gases such as CO₂ and H₂O and to avoid oxygen loss in the CaTiO₃ lattice for Ca₂Ni_{0.02}Ti_{0.98} and Ca₂Ni_{0.05}Ti_{0.95}. CH₄ partial oxidation (POx), MeOx(s)+CH₄(g)⇄MeOx−_{δ}(x)+CO(g)+2H₂(g), is accompanied by Ni species (NiO or Ca₁₊ₓNi_{y}Ti_{1-y}O₃) reduction. In-situ exsolution of Ni nanoparticles was also observed after CH₄-treatment at 800° C. for 1 h over the Ca₂Ni_{0.02}Ti_{0.98} and Ca₂Ni_{0.05}Ti_{0.95} MFMs in STEM-EDS mapping (FIG. 26). The onset temperatures of CH₄ POx over Ca₂Ni_{0.05}, Ca₂Ni_{0.02}Ti_{0.98}, and Ca₂Ni_{0.05}Ti_{0.95} are ≈485, ≈650, and ≈500° C., respectively. CH₄ POx at low temperatures (485-550° C.) is attributed to NiO reduction for Ca₂Ni_{0.05} and Ca₂Ni_{0.05}Ti_{0.95}, whereas CH₄ POx at ≈650° C. is ascribed to Ni species reduction in Ca₁₊ₓNi_{y}Ti_{1-y}O₃ perovskite for Ca₂Ni_{0.02}Ti_{0.98}. For Ca₂Ni_{0.05}Ti_{0.95} MFM, onset temperature of CH₄ POx by reduction of NiO (≈500° C.) is slightly higher than that of NiO species in Ca₂Ni_{0.05} DFM (485° C.), NiO(s)+CH₄(g)⇄Ni⁰(s)+CO(g)+2H₂(g), because the interaction between Ni and CaTiO₃ in Ca₂Ni_{0.05}Ti_{0.95} MFM is stronger than that between Ni and CaO in Ca₂Ni_{0.05} DFM. In addition, the broad H₂ peaks (550-700° C.) are attributed to the reduction of Ca₁₊ₓNi_{y}Ti_{1-y}O₃. For Ca₂Ni_{0.02}Ti_{0.98} MFM, the reduction of Ca₁₊ₓNi_{y}Ti_{1-y}O₃ between 650 and 700° C., Ca₁₊ₓNi_{y}Ti_{1-y}O_{3-δ′}(s)+βCH₄(g)⇄αNi⁰+αCaO+Ca_{1+x-α}Ni_{y-α}Ti_{1-y}O_{3-δ′}(s)+βCO(s)+2βH₂(g), is much higher than that for Ca₂Ni_{0.05}Ti_{0.95} MFM. After H₂ reduction of Ca₂Ni_{0.02}Ti_{0.98} MFM, CH₄ POx by the reduction of Ca₁₊ₓNi_{y}Ti_{1-y}O₃ was not observed during the CH₄-TPSR (FIG. 27). It is assumed that NiO on the surface of CaTiO₃ in the Ca₂Ni_{0.05}Ti_{0.95} MFM was reduced first by CH₄ (≈500° C.), and then products (CO and H₂) as reducing gases promoted Ni species reduction in the Ca₁₊ₓNi_{y}Ti_{1-y}O₃ (550-700° C.). Notably, the interaction between Ni species and support materials is as follows: Ca₂Ni_{0.02}Ti_{0.98}>>Ca₂Ni_{0.05}Ti_{0.95}>Ca₂Ni_{0.05}.

After NiO reduction, H₂ was produced over Ca₂Ni_{0.05} DFM at temperatures higher than 600° C., which is CH₄ decomposition over reduced Ni, CH₄(g)⇄C(s)+2H₂(g). In contrast, for Ca₂Ni_{0.02}Ti_{0.98} and Ca₂Ni_{0.05}Ti_{0.95} MFMs, H₂ gases were produced above 700° C., which is accompanied by CO production from in situ coke gasification by CaTiO₃, CaTiO₃(s)+C(s)⇄CaTiO_{3-δ}(s)+δCO(g). Although the Ca₂Ni_{0.05} DFM was reduced at lower temperatures, CH₄ decomposition activity at 800° C. is lower than that of Ca₂Ni_{0.02}Ti_{0.98} and Ca₂Ni_{0.05}Ti_{0.95} MFMs because of poor Ni dispersion (Table S2). This phenomenon was also observed in the CH₄-TPR of the bare CaTiO₃ perovskite (Ca₁Ti₁), making CO and H₂ at temperatures higher than 600° C. (FIG. 28).

TABLE S2
BET surface area, pore volume, porosity, dispersion, and metal surface
area of the Ca₂Ni_{0.05}, Ca₂Ni_{0.02}Ti_{0.98} and Ca₂Ni_{0.05}Ti_{0.95}.

| | BET | | | | Metal |
|---|---|---|---|---|---|
| | surface | | | | surface |
| | area | Pore volume | Porosity | Dispersion | area |
| | (m²/g)^{a} | (cm³/g)^{a} | (%)^{b} | (%)^{c} | (m²/g_{Ni})^{c} |
| Ca₂Ni_{0.05} | 4.59 | 0.056 | 72.9 | 10.2 | 1.35 |
| Ca₂Ni_{0.02}Ti_{0.98} | 20.7 | 0.176 | 85.8 | 65.5 | 2.65 |
| Ca₂Ni_{0.05}Ti_{0.95} | 19.2 | 0.183 | 85.6 | 20.3 | 2.08 |

^{a}BET surface area and pore volume were measured by N₂ adsorption-desorption isotherms.
^{b}Porosity was measured by Hg intrusion
^{c}Ni dispersion and metal surface area were obtained by H₂-pulse chemisorption.

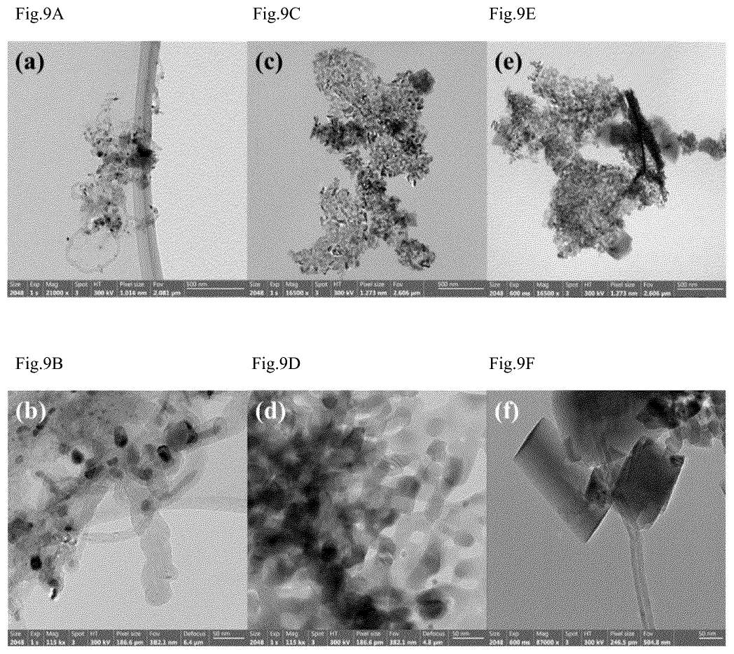

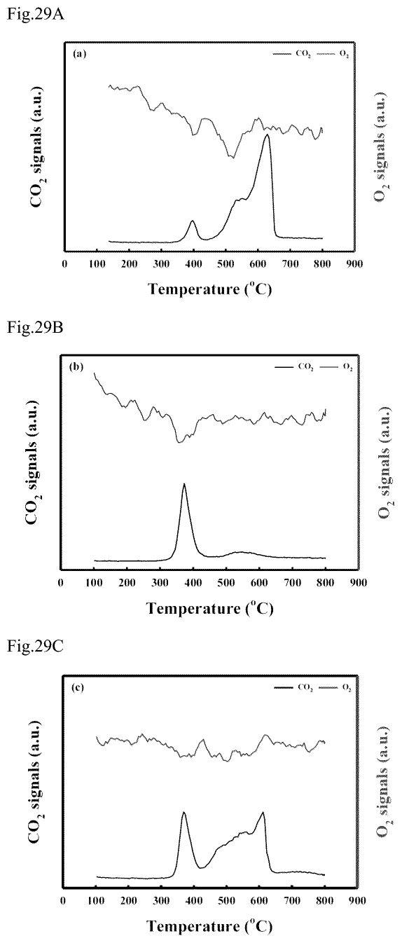

FIG. 8B shows the temperature programmed oxidation (TPO) profiles of Ca₂Ni_{0.05}, Ca₂Ni_{0.02}Ti_{0.98}, and Ca0₂Ni_{0.05}Ti_{0.95} after CH₄ treatment at 800° C. for 1 h. It is widely recognized that the temperature of coke combustion is highly dependent on its location and properties. A lower combustion temperature of the deposited coke leads to increased oxygenation, while proximity to the active site catalyzes combustion. Closer proximity of coke to catalysts is usually observed in the form of encapsulating coke, whereas filamentous coke is located away from the metallic sites. Three different types of CO₂ peaks can be identified in the TPO profiles for Ca₂Ni_{0.05}, Ca₂Ni_{0.02}Ti_{0.98}, and Ca₂Ni_{0.05}Ti_{0.95} at 300-400° C. (Type I), 400-600° C. (Type II) and 550-650° C. (Type III).^{[8]} The peaks at lower temperatures (Type I) correspond to the combustion of a non-filamentous or encapsulating coke closer to the active sites catalyzing coke combustion. The peaks at higher temperatures (Type II) are ascribed to the filamentous coke between the catalysts and support materials, which have grown from the catalyst's surface. However, the Type III CO₂ peaks are assumed to be the desorption of CO₂ captured by CaO at lower temperatures during the TPO because there is no O₂ consumption in this range (FIG. 29). Ca₂Ni_{0.05} DFM shows a small amount of Type I coke combustion at ≈400° C. and a higher fraction of overlapped Type II and III CO₂ peaks at temperatures between 450 and 650° C., indicating filamentous coke deposition. Noticeable filamentous coke was observed between Ni and CaO in high-resolution transmission spectroscopy (HRTEM) in (FIGS. 9A-9B). For Ca₂Ni_{0.02}Ti_{0.98} MFM, non-filamentous coke combustion (Type I) between 330 and 450° C. and small peaks of filamentous coke combustion (Type II) between 500 and 600° C. were observed. Filamentous coke is less likely to be deposited between exsolved Ni nanoparticles and CaTiO₃ due to the submerged interaction with the perovskite oxide, and filamentous coke deposition was observed in Ca₂Ni_{0.02}Ti_{0.98} MFM (FIGS. 9C-9D). Although the intensity of type I coke combustion for Ca₂Ni_{0.02}Ti_{0.98} and Ca₂Ni_{0.05}Ti_{0.95} MFMs are comparable, Ca₂Ni_{0.05}Ti_{0.95} MFM exhibited higher CO₂ intensity of type II and III because larger Ni nanoparticles coexisted with in-situ exsolved smaller Ni nanoparticles in Ca₂Ni_{0.05}Ti_{0.95} MFM. Compared to Ca₂Ni_{0.05}DFM, the Type II coke in Ca₂Ni_{0.05}Ti_{0.95} MFM was gasified at lower temperatures, meaning closer proximity of Ni nanoparticles to coke deposited. A small amount of filamentous coke between Ni and CaTiO₃ perovskite was observed (FIGS. 9E-9F). Despite the higher CH₄ decomposition activity, smaller size of Ni nanoparticles, strong interactions between socketed Ni and host CaTiO₃ perovskite, and lattice oxygen of CaTiO₃ in the Ca₂Ni_{0.02}Ti_{0.98} MFM could alleviate the filamentous coke deposition during the ICCDRM at lower temperature (700° C.). It is also expected that the deposited coke on the surface of Ni nanoparticles (Type I) during the DRM step is likely to be gasified by CO₂ to CO during the subsequent CO₂ capture step, C(s)+CO₂(g)⇄2CO(g).

### 2.3 ICCDRM Performance

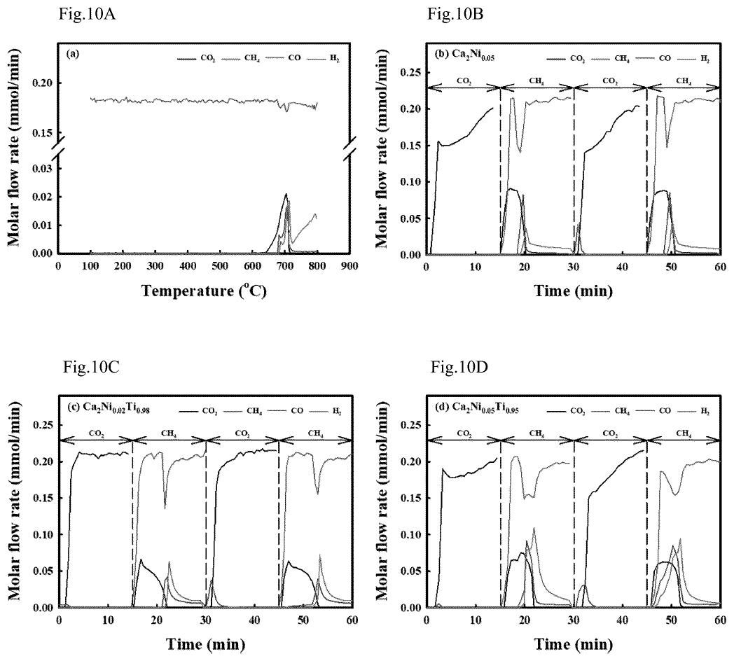

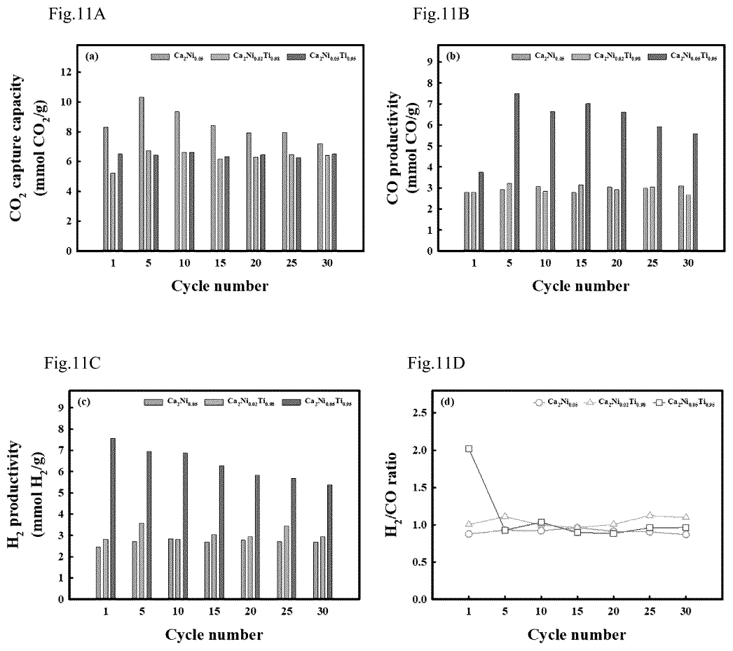

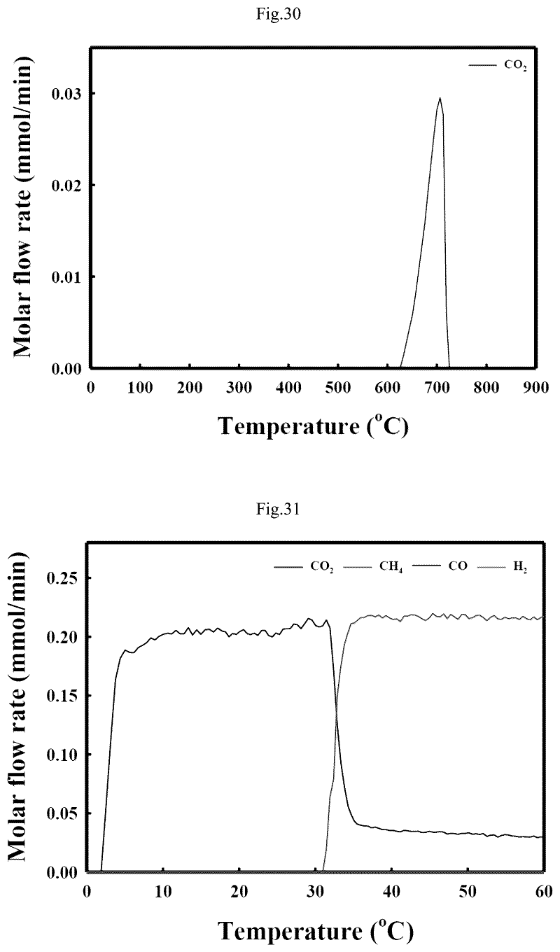

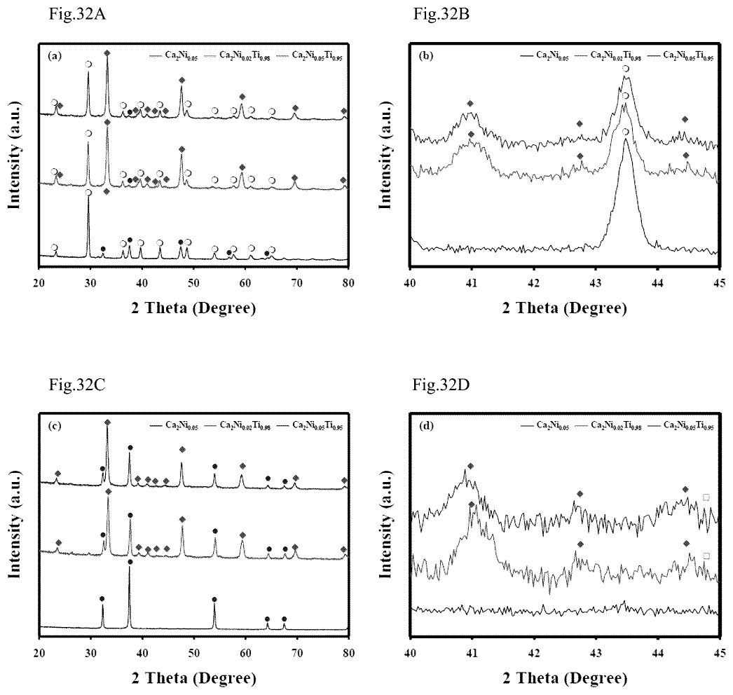

CH₄-TPSR after CO₂ capture was conducted over Ca₂Ni_{0.02}Ti_{0.98} MFM to determine the optimal reaction temperature for the ICCDRM process (FIG. 10A). Prior to CH₄-TPSR, the Ca₂Ni_{0.02}Ti_{0.98} MFM was carbonated under 10 vol % CO₂/He condition at 700° C. for 1 h. The onset temperature of CO₂ desorption was observed at ≈620° C. during the TPD under pure He condition (FIG. 30). The re-incorporated Ni species (Ca₁₊ₓNi_{y}Ti_{1-y}O₃ phase) during the CO₂ capture step can be reduced at ≈680° C., which is accompanied by CH₄ POx Ca₁₊ₓNi_{y}Ti_{1-y}O_{3-δ}(1−x)CaCO₃(s)+(β+1−x)CH₄(g)⇄αNi⁰/Ca₁₋ₓNi_{y-α}iTi_{1-y}O_{3-δ′}(s)+(β+1−x)CO(g)+2(β+1−x)H₂(g) as mentioned above. Then, the desorbed CO₂ and CH₄ reacted to syngas (CO and H₂) via DRM over metallic Ni between 680 and 720° C., CO₂(g)+CH₄(g)⇄2CO(g)+2H₂(g). During the DRM, the desorbed CO₂ reacts with H₂ produced from DRM to CO, CO₂(g)+H₂(g)⇄CO(g)+H₂O(g), leading to the decrease in H₂/CO ratio (below 1). After the complete DRM reaction, CH₄ decomposed to coke and H₂, CH₄(g)⇄C(s)+2H₂(g), and the H₂ productivity increased with reaction temperature. During the ICCDRM over Ca₂Ni_{0.02}Ti_{0.98} MFM at 650° C., syngas was not produced for 30 min (FIG. 31). The performance, such as CO₂ capture and syngas production of the MFMs in the ICCDRM, was investigated during the 30 cycles of CO₂ and CH₄ streams at 700° C. To study the redox properties of Ni species and consecutive reactions under CO₂ and CH₄ conditions, the ICCDRM process was conducted with high WHSV (60 000 ml g h⁻¹). FIGS. 10B-10D shows the CO₂ breakthrough curves and DRM profiles of Ca₂Ni_{0.05}, Ca₂Ni_{0.02}Ti_{0.98}, and Ca₂Ni_{0.05}Ti_{0.95} in the first 2 cycles of ICCDRM and overall reactions occurred at each step (H₂ reduction, CO₂ capture, and DRM) in the ICCDRM are summarized in Table S3. Before the CO₂ capture step, all samples were reduced under 5 vol % H₂/He at 800° C. for 1 h, and then the temperature decreased to 700° C. under He condition. During the CO₂ capture step (10 vol % CO₂/He stream), the molar flow rate of outlet CO₂ was lower than that of inlet CO₂ at the beginning of the reaction because of CO₂ capture by CaO to form CaCO₃, CaO(s)+CO₂(g)⇄CaCO₃(g). In addition to the CO₂ capture by CaO, reoxidation of metallic Ni into NiO and Ca₁₊ₓNi_{y}Ti_{1-y}O₃ was accompanied by small amount of CO production; Ni⁰(s)+CO₂(g)⇄NiO(s)+CO(g) for Ca₂Ni_{0.05} and Ca₂Ni_{0.05}Ti_{0.95}, and αNi⁰/Ca_{1+x-α}Ni_{y-α}Ti_{1-y}O_{3-δ′}(s)+βCO₂(g)⇄Ca₁₊ₓNi_{y}Ti_{1-y}O_{3-δ}(s)+βCO(g) for Ca₂Ni_{0.02}Ti_{0.98} and Ca₂Ni_{0.05}Ti_{0.95}. XRD results also confirmed that most of the CaO in all samples was converted into CaCO₃ at 700° C. and Ni⁰ peak disappeared after carbonation (FIGS. 32A-32B).

TABLE S3
Main reaction over Ca₂Ni_{0.02}Ti_{0.98} MFM during H₂-reduction, CO₂ capture,
and DRM steps in the ICCDRM.
Ca₂Ni_{0.05} DFM

| | |
|---|---|
| H₂ reduction | xNiO/CaO(s) + xH₂(g) |
| | ↔ xNi⁰/CaO(s) + xH₂O(g) |
| CO₂ capture | xNi⁰/CaO(s) + (x + 1)CO₂(g) |
| | ↔ xNiO/CaCO₃(s) + xCO(g) |
| DRM | xNiO/CaCO₃(s) + (x + y + 1)CH₄(g) |
| | ↔ yC/xNi⁰/CaO(s) + (x + 2)CO(g) + 2(x + y + 1)H₂(g) |

Ca₂Ni_{0.02}Ti_{0.98} MFM

| | |
|---|---|
| H₂ reduction | Ca₁ + ₓNi_{y}Ti_{1-y}O_{3-δ}/(1 − x)CaO(s) + βH₂(g) |
| | ↔ αNi⁰/Ca_{1+x-α}Ni_{y-α}Ti_{1y}O_{3-δ′}/(α + 1 − x)CaO(s) + βH₂O(g) |
| CO₂ capture | αNi⁰/Ca_{1+x-α}Ni_{y-α}Ti_{1-y}O_{3-δ′}(α + 1− x)CaO(s) + (β + 1 − x)CO₂(g) |
| | ↔ Ca₁₊ₓNi_{y}Ti_{1-y}O_{3-δ}/(1 − x)CaCO₃(s) + βCO(g) |
| DRM | Ca₁₊ₓNi_{y}Ti_{1-y}O_{3-δ}/(1 − x)CaCO₃(s) + (β + 1 − x)CH₄(g) |
| | ↔ αNi⁰/Ca_{1+x-α}Ni_{y-α}Ti_{1-y}O_{3-δ′}/(α + 1− x)CaO(s) + (β + 2 − 2x)CO₂(g) + 2(β + 1 − x)H₂(g) |

Ca₂Ni_{0.05}Ti_{0.95} MFM

| | |
|---|---|
| H₂ reduction | zNiO/Ca₁₊ₓNi_{y-z}Ti_{1-y-z}O_{3-δ}/(1 − x)CaO(s) + (z + β)H₂(g) |
| | ↔ (z + α)Ni⁰/Ca_{1+x-α}Ni_{y}Ti_{1-y-z}O_{3-δ′}/(1 − x + α)CaO(s) + (z + β)H₂O(g) |
| CO₂ capture | (z + α)Ni⁰/Ca_{1+x-α}Ti_{1-y-z}O_{3-δ′}/(1 − x + α)CaO(s) + (z + β + 1 − x)CO₂(g) |
| | ↔ zNiO/Ca₁₊ₓNi_{y}Ti_{1-y-z}O_{3-δ}/(1 − x)CaO(s) + (z + β)CO(g) |
| DRM | zNiO/Ca₁₊ₓNi_{y}Ti_{1-y-z}O_{3-δ}/(1 − x)CaCO₃(s) + (z + β + 1 − x)CH₄(g) |
| | ↔ (z + α)Ni⁰/Ca_{1+x-α}Ni_{y}Ti_{1-y-z}O_{3-δ′}/(1 − x)CaO(s) + (z + β + 2 − 2x)CO(g) + 2(z + β + 1 − x)H₂(g) |

During the subsequent DRM step (10 vol % CH₄/He stream), the CO₂ was desorbed from CaCO₃, and the molar flow rate of outlet CH₄ initially reached that of inlet CH₄ because of the high WHSV, as mentioned above. CH₄ reacted with the desorbed CO₂ to CO and H₂ over metallic Ni, CO₂(g)+CH₄(g)⇄2CO(g)+2H₂(g). The time when the highest CH₄ conversion was achieved for Ca₂Ni_{0.05}, Ca₂Ni_{0.02}Ti_{0.98}, and Ca₂Ni_{0.05}Ti_{0.95} are 19.2, 21.6, 19.8 min, respectively, which has inversely proportional to the interaction between Ni species and support materials (Ca₂Ni_{0.02}Ti_{0.98}>>Ca₂Ni_{0.05}Ti_{0.95}>Ca₂Ni_{0.05}), as stated in FIG. 3A. This is because the NiO supported on CaO (Ca₂Ni_{0.05}) or CaTiO₃ (Ca₂Ni_{0.05}Ti_{0.95}) were reduced fast, compared to the Ca₁₊ₓNi_{y}Ti_{1-y}O₃ in Ca₂Ni_{0.02}Ti_{0.98}. Therefore, more desorbed CO₂ can be converted via DRM or rWGS reactions in the Ca₂Ni_{0.05} and Ca₂Ni_{0.05}Ti_{0.95}, compared to Ca₂Ni_{0.02}Ti_{0.98}. The H₂/CO ratio at the highest CH₄ conversion is below 1 because desorbed CO₂ reacts with H₂ produced from DRM to produce CO via rWGS, CO₂(g)+H₂(g)⇄CO(g)+H₂O(g). In addition to the DRM reaction, CH₄ decomposed to coke and H₂, CH₄(g)⇄C(s)+2H₂(g), after complete CO₂ desorption. For Ca₂Ni_{0.02}Ti_{0.98} and Ca₂Ni_{0.05}Ti_{0.95} MFMs, the deposited coke was in-situ gasified by lattice oxygen in CaTiO₃.

At the 2nd CO₂ capture step, in addition to the Ni species oxidation, coke deposited during the 1st DRM step was gasified by CO₂ to CO via reverse Boudouard reaction at the beginning of the reaction, C(s)+CO₂(g)⇄2CO(g). Therefore, the CO produced at the 2nd CO₂ capture is significantly higher than at the 1st cycle. At the 2nd DRM step, Ca₂Ni_{0.05} DFM exhibited similar results to the first DRM step. For the Ca₂Ni_{0.02}Ti_{0.98} MFM, a small amount of CO gas was produced at the beginning of the reaction (48-50 min). This phenomenon is assumed that Ca₁₊ₓNi_{y}Ti_{1-y}O₃ was reduced by CH₄ to make CO and H₂, Ca₁₊ₓNi_{y}Ti_{1-y}O_{3-δ}(s)+βCH₄(g)⇄αNi⁰/Ca_{1+x-α}Ni_{y-α}Ti_{1-y}O_{3-δ′}(s)+βCO(g)+2βH₂(g). Then the produced H₂ reacts subsequently with desorbed CO₂ to CO via rWGS, CO₂(g)+H₂(g)⇄CO(g)+H₂O(g). This implies that the partially re-incorporated Ni nanoparticles during the rapid CO₂ capture step were easily reduced under the CH₄ stream compared to the 1st cycles. Ca₂Ni_{0.05}Ti_{0.95} MFM exhibited a notable increase in CO and H₂ production at the beginning of the reaction (46-50 min). In the XRD results after the DRM step, all CaCO₃ converted to CaO and small Ni⁰ peak appeared after 30 cycles of ICCDRM (FIGS. 32C-32D).

FIG. 11 exhibited CO₂ capture capacity, syngas (CO and H₂) productivity, and H₂/CO ratio of Ca₂Ni_{0.05}, Ca₂Ni_{0.02}Ti_{0.98}, and Ca₂Ni_{0.05}Ti_{0.95} during 30 cycles of ICCDRM at 700° C. to compare the CO₂ capture efficiency, catalytic activity, and deactivation properties during cyclic tests. CO₂ capture capacity and syngas productivity were calculated from the CO₂ breakthrough curves and DRM profiles, respectively. H₂/CO ratio is calculated from the overall CO and H₂ productivity during the DRM step. At the 1st cycle, CO₂ capture capacity of Ca₂Ni_{0.05}, Ca₂Ni_{0.02}Ti_{0.98}, and Ca₂Ni_{0.05}Ti_{0.95} were 8.28, 5.19 and 6.49 mmol CO₂/g, respectively. Ca₂Ni_{0.05} DFM showed the highest CO₂ capture capacity because of its higher CaO content without CaTiO₃, compared to the Ca₂Ni_{0.02}Ti_{0.98} and Ca₂Ni_{0.05}Ti_{0.95} MFMs. CO₂ capture capacity of Ca₂Ni_{0.05} DFM increased to 10.3 mmol CO₂/g due to the morphology change of CaO/CaCO₃ molecules during the 1st cycle of ICCDRM. Then, it decreased gradually to 7.19 mmol CO₂/g because of the thermal sintering of CaO. The crystallite size of CaO increased from 28.5 to 47.9 nm after 30 cycles of ICCDRM at 700° C. (Table S4). On the other hand, Ca₂Ni_{0.02}Ti_{0.98} and Ca₂Ni_{0.05}Ti_{0.95} MFMs exhibited stable CO₂ capture capacity during the 30 cycles of ICCDRM at 700° C. This is because the CaTiO₃ acted as a physical barrier intra-region of CaO/CaCO₃ molecules, which alleviated the thermal sintering of CaO. The crystallite size of CaO in Ca₂Ni_{0.02}Ti_{0.98} and Ca₂Ni_{0.05}Ti_{0.95} MFM increased slightly after 30 cycles of ICCDRM at 700° C. (Ca₂Ni_{0.02}Ti_{0.98}: 28.1 to 29.9 nm and Ca₂Ni_{0.05}Ti_{0.95}: 24.7 to 31.2 nm).

TABLE S4
Crystallite size of CaO in Ca₂Ni_{0.05}, Ca₂Ni_{0.02}Ti_{0.98} and Ca₂Ni_{0.05}Ti_{0.95}
after 30 cycles of ICCDRM at 700° C. (carbonation: 10 vol. %
CO₂/He for 15 min and DRM: 10 vol. % CH₄ for 15 min).

| | Crystallite size (nm)^{a} | |
|---|---|---|
| | As prepared | After reactions |
| Ca₂Ni_{0.05} | 28.5 | 47.9 |
| Ca₂Ni_{0.02}Ti_{0.98} | 24.7 | 29.9 |
| | 27 | |
| Ca₂Ni_{0.05}Ti_{0.95} | 24.3 | 31.2 |

^{a}Crystallite size of NiO and CaO was calculated by Scherrer's equation from XRD.

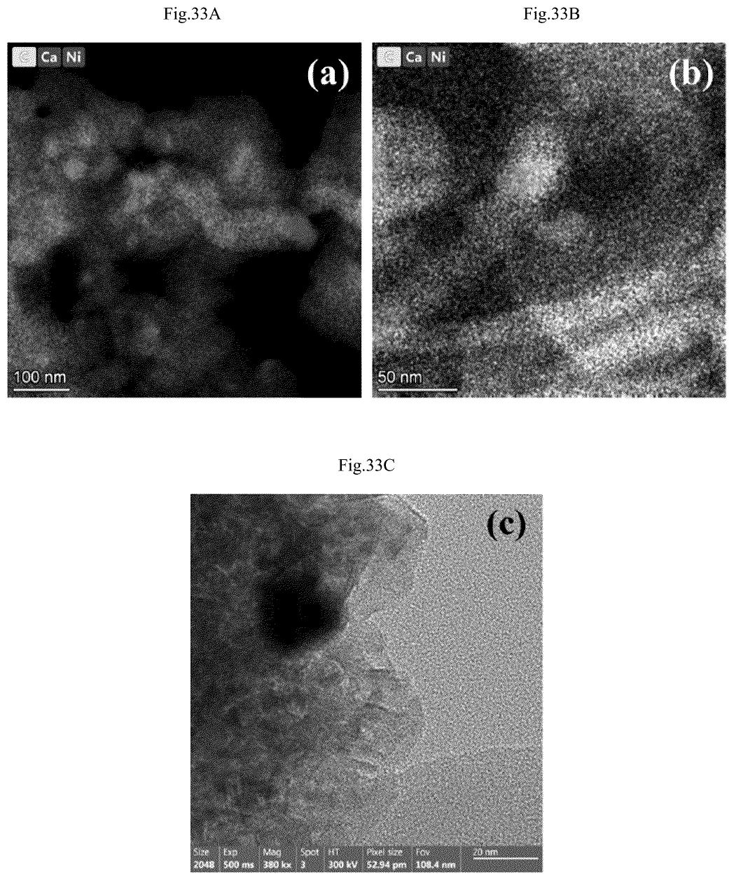

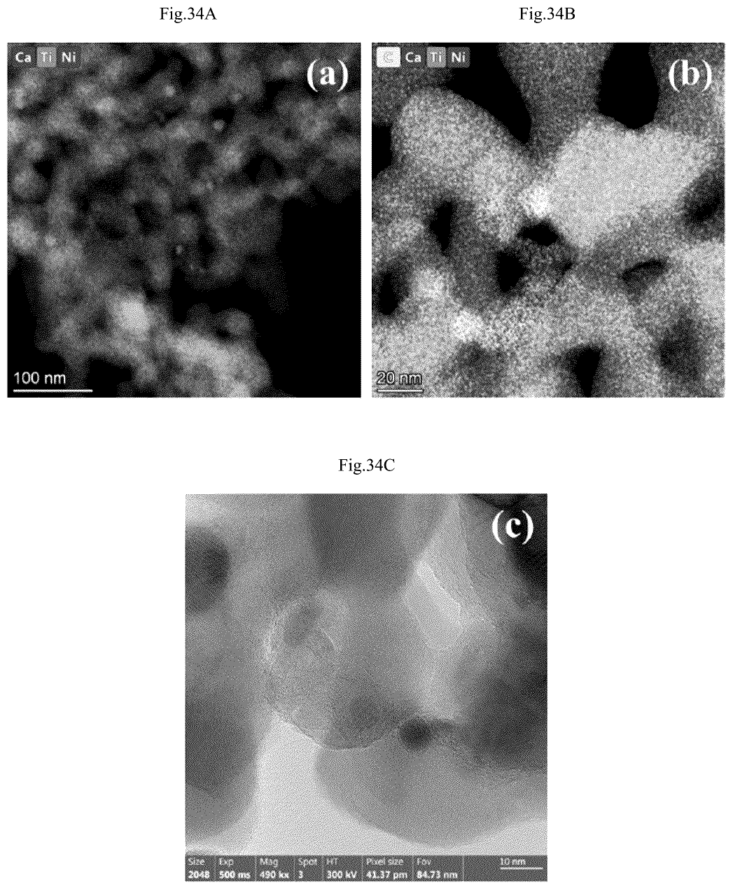

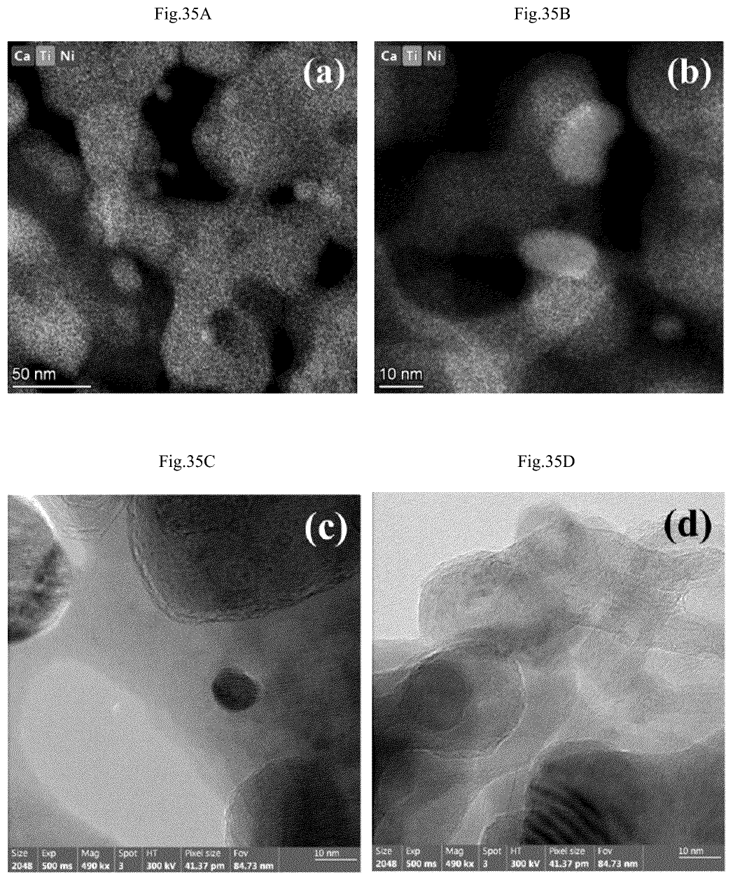

During the subsequent DRM, syngas productivity of Ca₂Ni_{0.05} DFM increased slightly during the 30 cycles (CO: 3.26-3.61 mmol CO/g and H₂: 2.41-2.65 mmol H₂/g) because of higher CO₂ capture capacity than that at the 1st cycle. However, the overall H₂/CO ratio decreased slightly from 0.87 to 0.73, resulting from decreased CH₄ decomposition because of severe coke accumulation with cycles. After 30 cycles of ICCDRM, severe Ni nanoparticle sintering and filamentous coke deposition between Ni and large-size nanoparticles were observed in STEM-EDS images (FIG. 33). Coke-encapsulating Ni nanoparticles were not observed in the HRTEM image. For Ca₂Ni_{0.02}Ti_{0.98} MFM, syngas (CO and H₂) productivity increased slightly, and the H₂/CO ratio was maintained from 0.96 to 1.12. After 30 cycles of ICCDRM at 700° C., the crystallite size of Ni measured by STEM-EDS images is comparable to that of the freshly reduced samples (FIG. 34). A very thin layer of coke encapsulating Ni nanoparticles was observed in the HRTEM image. For Ca₂Ni_{0.05}Ti_{0.95} MFM, CO productivity at the 1st cycle is 3.74 mmol CO/g and increased to 7.49 mmol CO/g at the 5th cycle because of the increase in CO production at the beginning of the DRM step, as mentioned above. CO productivity decreased gradually to 5.58 mmol CO/g after the 5th cycle. H₂ productivity gradually reduced from 7.56 to 5.37 mmol H₂/g during the 30 cycles. As mentioned above, the H₂/CO ratio at the 1st cycle is 2.02 and then reduced to 0.88-1.03 because of a significant increase in CO production. Ni nanoparticle sintering was not observed in the STEM-EDS images after 30 cycles of ICCDRM (FIG. 35). In the HRTEM image of Ca₂Ni_{0.05}Ti_{0.95} MFM after 30 cycles of ICCDRM, coke encapsulating Ni nanoparticles were observed on the Ni with small crystallite size (≈8 nm) that is strongly adhered to the CaTiO₃ perovskite (FIG. 35C). FIG. 35D shows Ni encapsulated by a thick layer of coke with larger crystallites (≈20 nm) and filamentous coke between Ni and CaTiO₃.

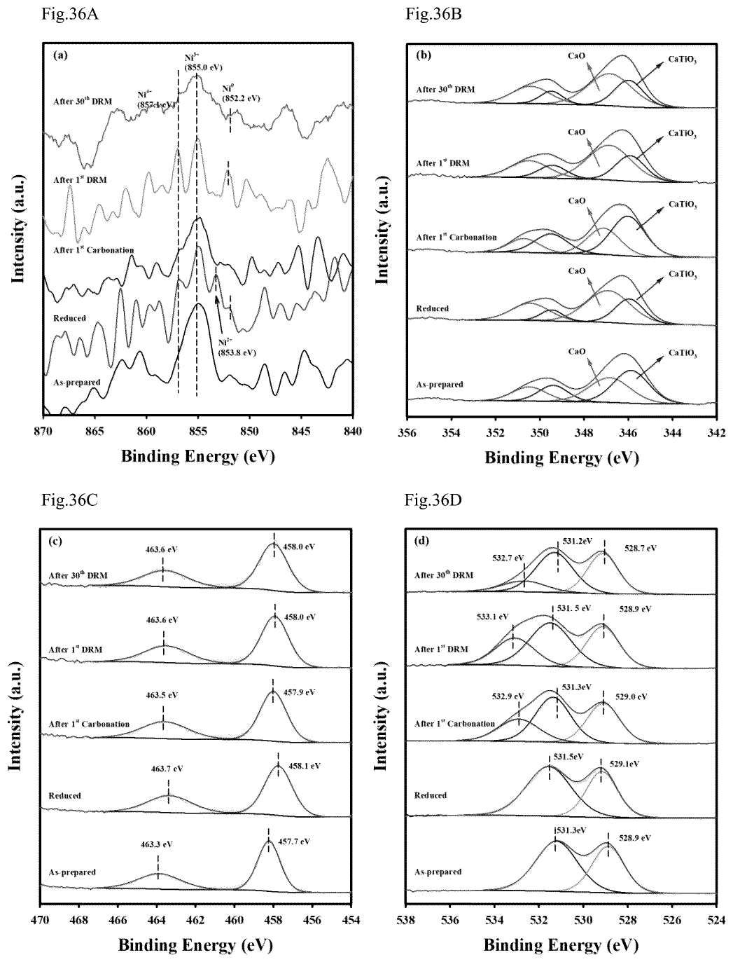

To prove the self-regeneration properties (Ni exsolution and re-incorporation) of Ni-doped CaTiO₃/CaO MFM, XPS spectra measurements were conducted after ICCDRM reactions (FIG. 36). Although Ni XPS spectra were unclear due to the low Ni amount in the sample, it was observed that Ni⁰ peak appeared after reduction decreased after carbonation step, and then Ni⁰ peak appeared again after the 1st and 30th DRM steps. During the self-regeneration, not all Ni species were exsolved and some parts of Ni species existed as Ni⁴⁺/Ni³⁺ in the Ca₁₊ₓNi_{y}Ti_{1-y}O₃ perovskite. In the Ca 2p spectra, CaO-to-CaTiO₃ ratio increased after reduction due to the exsolution of CaO, and then decreased after carbonation step, which was accompanied by Ni re-incorporation. After DRM step, CaO-to-CaTiO₃ ratio decreased. In the Ti 2p spectra, binding energy values of Ca₂Ni_{0.02}Ti_{0.98} MFM were lower than those of CaTiO₃, as mentioned above (Figure). After reduction, Ti 2p peaks shifted to higher biding energy, which is comparable to that of CaTiO₃. The Ti 2p peaks decreased after carbonation, and then increased after DRM step. In the O 1s spectra, a new peak was observed at ≈533 eV after carbonation step, which might be absorbed CO₂ by CaO (CO₃²⁻). However, the peak at ≈533 eV was still observed after DRM steps. Considering complete conversion of CaCO₃ to CaO in the XRD result, the peak might be attributed to active CHx during DRM step.^{[29]} Based on the XRD, XPS and STEM results, it is concluded that the exsolved Ni nanoparticles from the Ca₁₊ₓNi_{y}Ti_{1-y}O₃ can be re-incorporated after carbonation (oxidative condition), and then exsolved after DRM step (reductive condition).

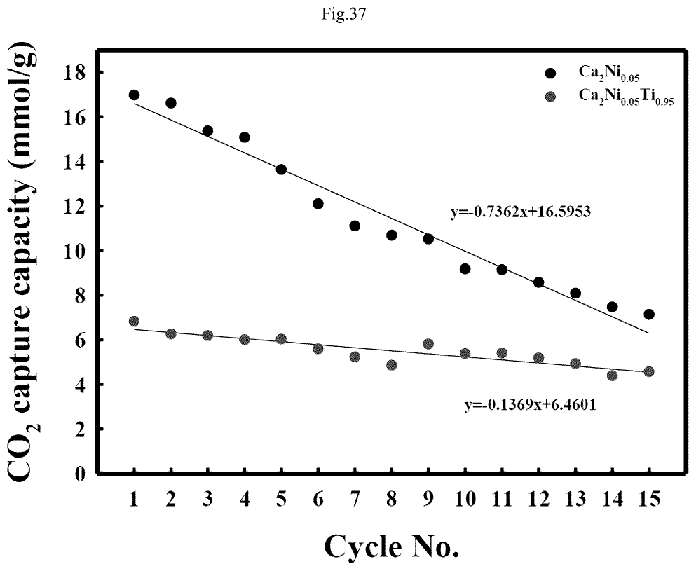

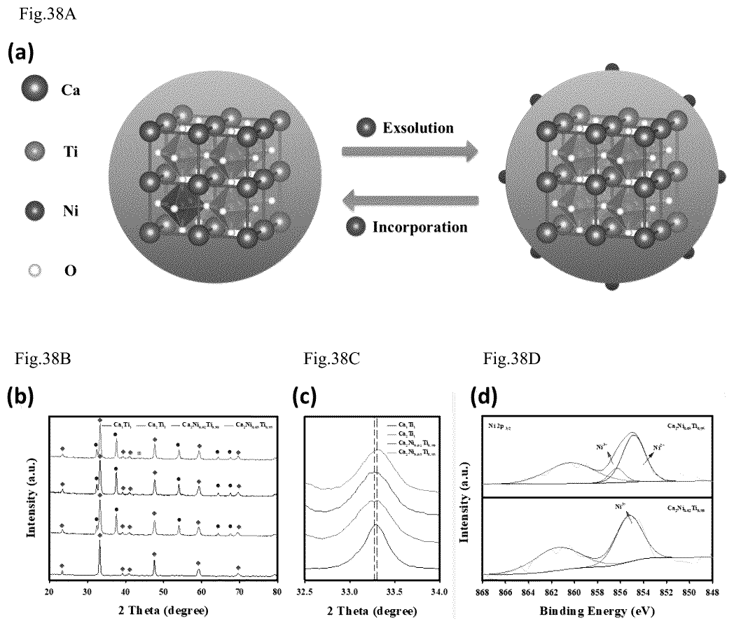

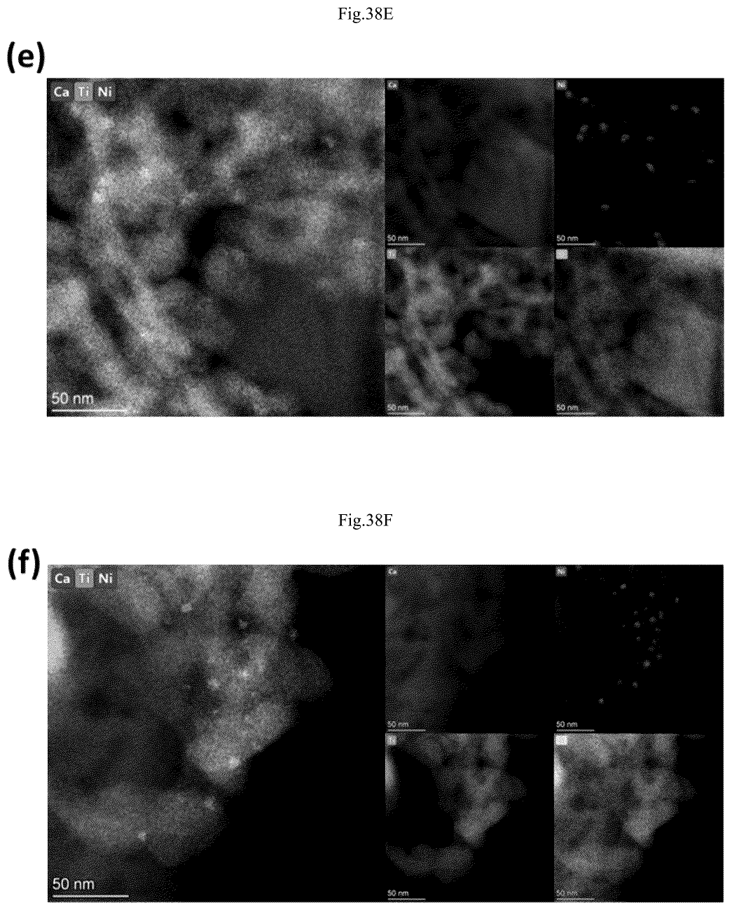

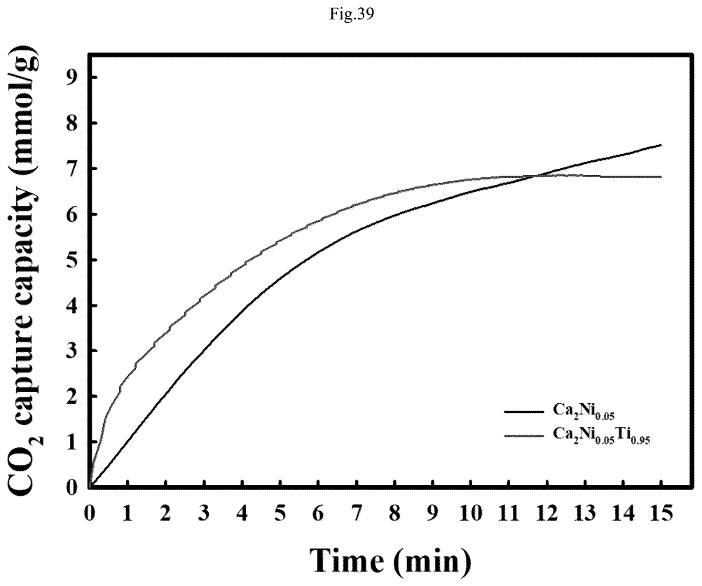

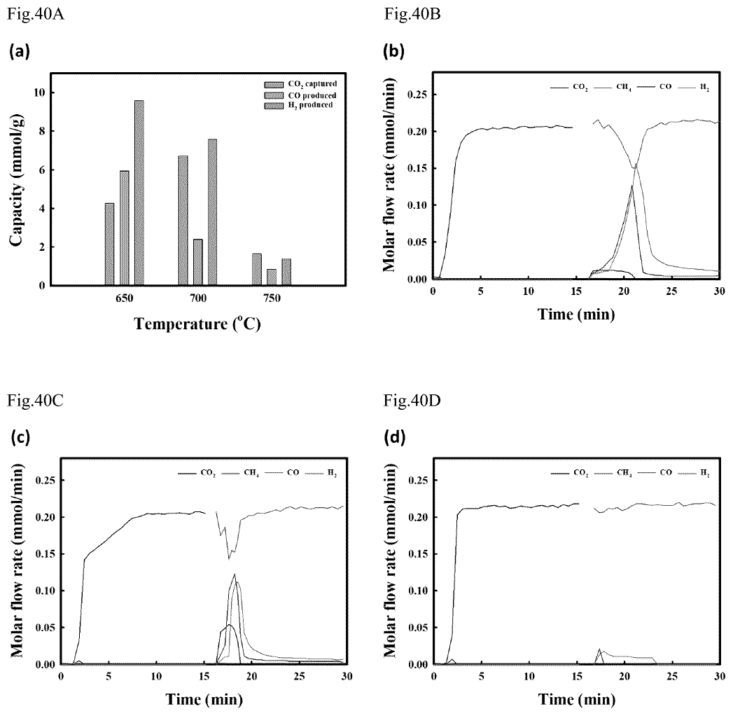

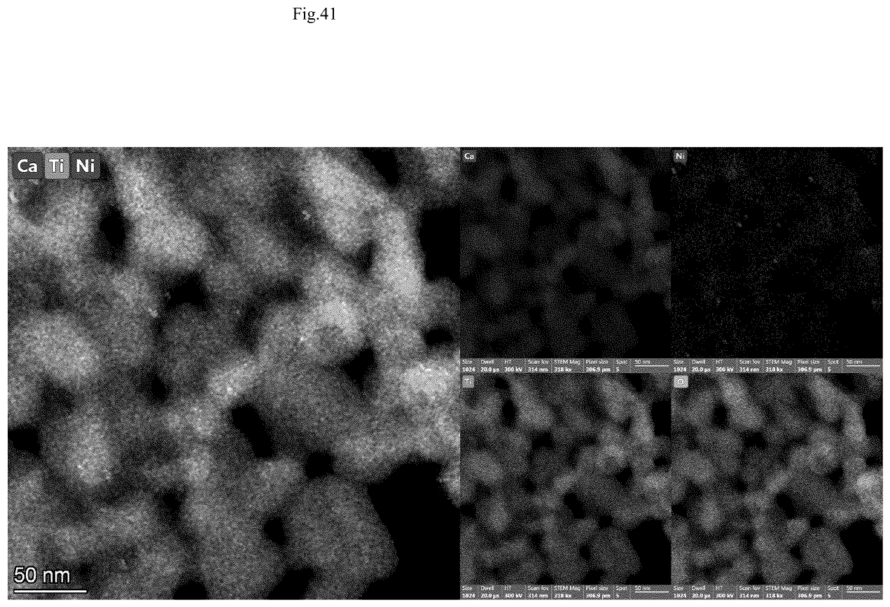

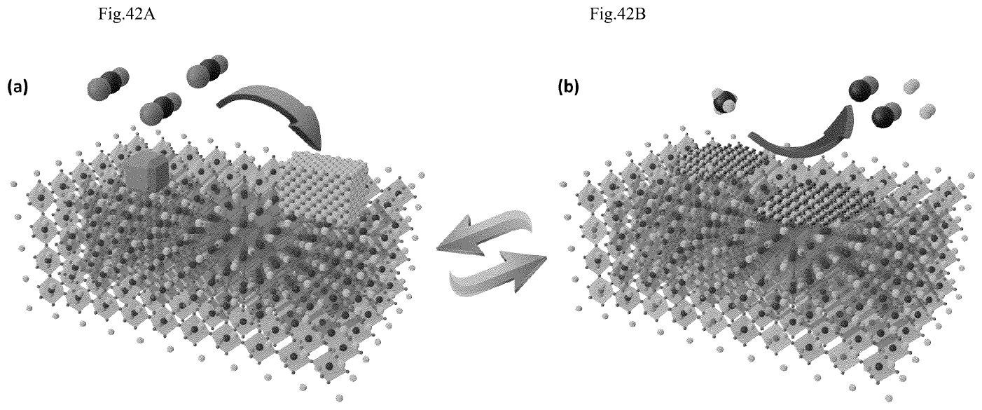

Conventional carbonation and decarbonation studies (carbonation: 10 vol % CO₂/He at 700° C. for 15 min and decarbonation: 100 vol % He at 900° C. for 15 min) were conducted over Ca₂Ni_{0.05} DFM and Ca₂Ni_{0.05}Ti_{0.95} MFM to study NiO sintering caused by the stress-induced sintering of CaO/CaCO₃ (FIG. 37). As mentioned above, NiO of Ca₂Ni_{0.05} DFM and Ca₂Ni_{0.05}Ti_{0.95} MFM are supported on the CaO and the CaTiO₃, respectively. The test over Ca₂Ni_{0.02}Ti_{0.98} MFM was not conducted because Ni species exist as Ca₁₊ₓNi_{y}Ti_{1-y}O₃ phase without NiO phase in the as-prepared sample. CO₂ capture capacity of Ca₂Ni_{0.05} DFM and Ca₂Ni_{0.05}Ti_{0.95} MFM at the 1st cycle is 16.97 and 6.82 mmol CO₂/g, respectively, because Ca₂Ni_{0.05} DFM contains more CaO contents than that of Ca₂Ni_{0.05}Ti_{0.95}MFM. The CO₂ capture capacity of Ca₂Ni_{0.05} DFM decreased gradually to 7.13 mmol CO₂/g at the 15^{th} carbonation due to the morphological changes of the CaO/CaCO₃ after decarbonation. For Ca₂Ni_{0.05}Ti_{0.95} MFM, CO₂ capture capacity slightly reduced from 6.82 to 4.56 mmol CO₂/g during 15 cycles of carbonation and decarbonation. The deactivation rate of CO₂ capture capacity during 15 cycles over Ca₂Ni_{0.05} DFM was ≈5.4-fold faster than that over Ca₂Ni_{0.05}Ti_{0.95} MFM because CaTiO₃ addition between CaO grains suppressed the agglomeration from the volume expansion of CaO/CaCO₃ during CO₂ capture in Ca₂Ni_{0.05}Ti_{0.95} MFM. The crystallite size of NiO and CaO before and after 15 cycles of carbonation/decarbonation were calculated using the Scherrer equation and are summarized in Table S5. The crystallite size of CaO in Ca₂Ni_{0.05} DFM increased from 28.5 to 34.0 nm. The changes in surface morphology and porosity of Ca₂Ni_{0.05} DFM from volume expansion of CaO/CaCO₃ structures, as well as relatively weak NiO—CaO interaction, could result in the aggregation of Ni species (15.9 to 38.2 nm) during the carbonation and decarbonation cycles. In contrast, the crystallite sizes of CaO and NiO of Ca₂Ni_{0.05}Ti_{0.95} MFM are comparable before and after 15 cycles of carbonation/decarbonation (CaO: 24.3 to 26.0 nm, and NiO: 14.0 to 12.7 nm). The presence of CaTiO₃ in the intra-region of CaO grains could suppress the severe aggregation of CaO during carbonation and decarbonation cycles. In addition, NiO supported on CaTiO₃ instead of CaO/CaCO₃ decreases the occurrence of NiO mobility and sintering.

TABLE S5
Crystallite size of CaO and NiO in Ca₂Ni_{0.05} and Ca₂Ni_{0.05}Ti_{0.95}
after 15 cycles of conventional carbonation and decarbonation
(carbonation: 10 vol. % CO₂/He at 700° C. for 15 min and
decarbonation: 100 vol. % He at 900° C. for 15 min).

| | Crystallite size (nm)^{a} | |
|---|---|---|
| | As prepared | After reactions |
| Ca₂Ni_{0.05} | CaO: 28.5 | CaO: 34.0 |
| | NiO: 15.9 | NiO: 38.2 |
| | CaO: 28.5 | CaO: 34.0 |
| Ca₂Ni_{0.05}Ti_{0.95} | NiO: 15.9 | NiO: 38.2 |

^{a}Crystallite size of NiO and CaO was calculated by Scherrer's equation from XRD.

### 2.4 Mechanism of ICCDRM Over Self-Regenerative Ni-Doped CaTiO₃/CaO MFM

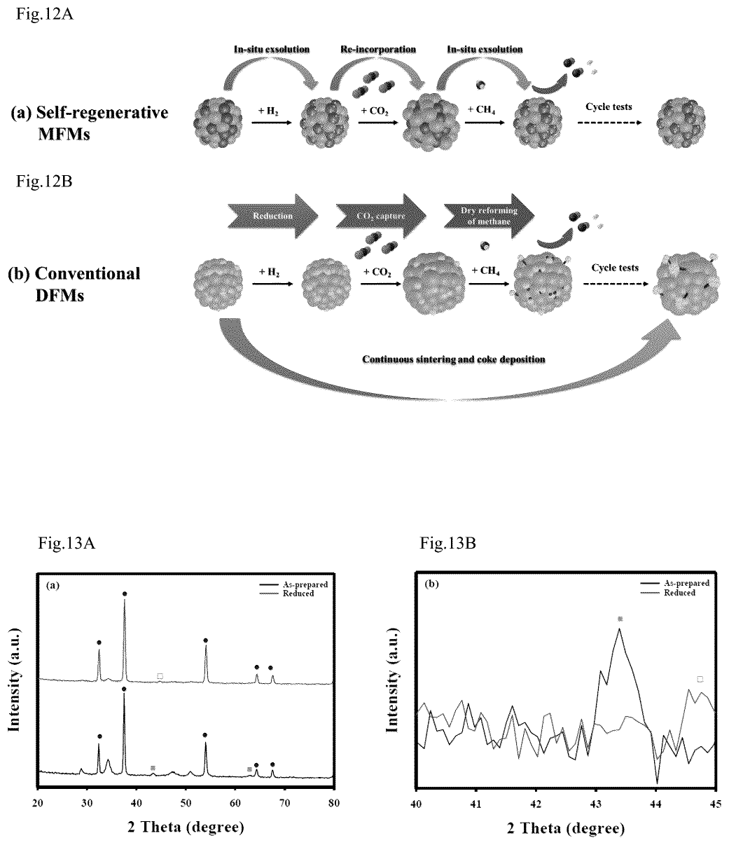

Based on the physicochemical analysis and experimental results, a schematic of the mechanism over the self-regenerative Ni-doped CaTiO₃/CaO (Ca₂Ni_{0.02}Ti_{0.98}) MFM and conventional Ni/CaO (Ca₂Ni_{0.05}) DFM in the ICCDRM process was illustrated (FIG. 12). For conventional Ni/CaO DFM, NiO supported on CaO is reduced to Ni metal under the H₂ reduction step, xNiO/CaO(s)+xH₂(g)⇄xNi⁰/CaO(s)+xH₂O(g). During the CO₂ capture step, the metallic Ni is oxidized by CO₂ (oxidative condition) to produce CO, and CaO captures CO₂ to produce CaCO₃, xNi⁰/CaO(s)+(x+1)CO₂(g)⇄xNiO/CaCO₃(s)+xCO(g). During the DRM step, NiO is reduced under CH₄ (reductive condition), and CO₂ desorbs from CaCO₃ and reacts with CH₄ to produce syngas (CO and H₂). In addition to DRM, CH₄ is decomposed to coke and H₂, exacerbating the formation of filamentous coke growth between Ni and CaO. The overall reaction is as follows: xNiO/CaCO₃(s)+(x+y+1)CH₄(g)⇄yC−xNi⁰/CaO(s)+(x+2)CO(g)+2(x+y+1)H₂(g). The stress induced by the cyclical volume expansion and shrinkage from CaO to CaCO₃ (CaO: 16.9 cm³/g and CaCO₃: 36.9 cm³ g⁻¹) during carbonation and decarbonation^{[9]} can contribute to rapid pore collapse of the structure. Additionally, the lower Tammann temperature of CaCO₃ (533° C.) than the DRM operation temperature (≈700° C.) causes the loss of surface

area, porosity, and sintering-induced decrease in CO₂ capture capacity.^{[9], [10]} During each cycle, the reversible phase transformation of CaO to CaCO₃ weakens the Ni—CaO metal support interaction, resulting in significant sintering of Ni nanoparticles on the surface of CaO.^{[11]}

For the self-regenerative Ni-doped CaTiO₃/CaO MFM, Ni nanoparticles are assembled and formed via exsolution from the Ca₂Ni_{0.02}Ti_{0.98} perovskite lattice. The formed Ni nanoparticles are evenly distributed and partially submerged or socketed in the CaTiO₃ perovskite oxide support and can be described by the equation: Ca₁₊ₓNi_{y}Ti_{1-y}O_{3-δ}/(1−x)CaO(s)+βH2(g)⇄αNi⁰/Ca_{1+x-α}Ni_{y-α}Ti_{1-y}O_{3-δ}/(1−x)CaO(s)+βH2O(g). During the CO₂ capture step, exsolved Ni nanoparticles are reincorporated into the subsurface of the CaTiO₃ lattice (e.g., self-regeneration) under CO₂ (oxidative condition), which is accompanied by CO production, and CaO reacts with CO₂ to produce CaCO₃; αNi⁰/Ca_{1+x-α}Ni_{y-α}Ti_{1-y}O_{3-δ}/(1−x)CaO(s)+(β+1−x)CO₂(g)⇄Ca₁₊ₓNi_{y}Ti_{1-y}O_{3-δ}/(1−x)CaCO₃(s)+βCO(g). Ni-doped CaTiO₃/CaO MFMs exhibited stable CO₂ capture capacity during cyclic ICCDRM because CaTiO₃ acts as a physical barrier between CaO grains, suppressing the CaO sintering from CaO/CaCO₃ volume expansion. During the subsequent DRM step, Ni nanoparticles exsolved from Ca₂Ni_{0.02}Ti_{0.98} perovskite under CH₄ (reductive condition) and CO₂ desorbed from CaCO₃ reacts with CH₄ to produce syngas (CO and H₂), Ca₁₊ₓNi_{y}Ti_{1-y}O_{3-δ}/(1−x)CaCO₃(s)+(β+1−x)CH₄(g)⇄αNi⁰/Ca_{1+x-α}Ni_{y-α}Ti_{1-y}O_{3-δ′}/(1−x)CaO(s)+(β+2−2x)CO(g)+2(β+1−x)H₂(g). Moreover, Tammann temperatures of Ni and NiO are much higher (Ni: 863° C. and NiO: 1114° C.) than the typical DRM operation temperature (700° C.).^{[10]} This means the Ni sintering in the Ca₂Ni_{0.05} DFM is predominately caused by the volume expansion (CaO to CaCO₃) and weak interaction between Ni and CaO during the cyclic ICCDRM. Therefore, the separation of Ni species socketed in CaTiO₃ from CaO grains prevents significant Ni sintering and prolongs ICCDRM activity.

### Conclusions

In this Example, Ni-doped CaTiO₃/CaO nanocomposite (Ca₂Ni_{0.02}Ti_{0.98}) as MFMs was prepared for ICCDRM. A small amount of Ni can be incorporated into CaTiO₃ perovskite as a Ca₁₊ₓNi_{y}Ti_{1-y}O₃ perovskite because of an unstable NiO₆ octahedron. In-situ exsolved Ni nanoparticles, which interact strongly with the CaTiO₃ perovskite oxide support, were evenly distributed on the surface after reductive conditions (H₂ or CH₄). The Ni nanoparticles exsolved in CaTiO₃ migrate back to the subsurface during CO₂ capture (oxidative conditions), resulting in self-regeneration. In addition, in-situ exsolved Ni nanoparticles, which interact strongly with host CaTiO₃ perovskite, exhibited excellent resistance to filamentous coke deposition under CH₄ conditions. Some deposited coke was in situ gasified by surface lattice oxygen of CaTiO₃ perovskite. The Ni-doped CaTiO₃/CaO MFM showed relatively stable CO₂ capture capacity and syngas productivity during 30 cycles of ICCDRM. The presence of CaTiO₃ between CaO grains prevented volume expansion, maintaining the CO₂ capture capacity. The strong interaction between Ni and CaTiO₃, separation from CaO/CaCO₃ morphology change, and self-regeneration during CO₂ capture and subsequent DRM (redox condition) can mitigate Ni sintering. Due to the small size of exsolved Ni particles and their strong interaction with CaTiO₃, there was no severe coke build-up. Additionally, coke gasification occurred by lattice oxygen during the CO₂ capture process. Therefore, our results show that Ni-doped CaTiO₃/CaO MFM can potentially overcome current challenges for the ICCDRM process. Future efforts will optimize the self-regenerative MFMs for improved ICCDRM performance and multicycle stability.

### Experimental Section

### Preparation of MFMs

The CaₓNi_{y}Ti_{1-y} (x=1, and 2, and y=0, 0.01, 0.02, and 0.05) perovskite materials were prepared using the sol-gel Pechini method. Ni(NO₃)₂·6H₂O (Alfa Aesar), Ca(NO₃)₂·4H₂O (Sigma-Aldrich), and Ti(C₄H₉O)₄ (Arcros Organics) were used for the Ni, Ca and Ti precursors, respectively. Citric acid (Alfa Aesar) and ethylene glycol butyl ether (Sigma-Aldrich) were used as chelating and polymerization agents. The required amounts of metal precursors were mixed in a stoichiometric ratio and dissolved in DI water to form an aqueous solution. Citric acid (the molar ratio of citric acid to metal ions was 1) and ethylene glycol butyl ether (the molar ratio of citric acid to ethylene glycol butyl ether was 3) were added into the precursor solution. The solution was dried in an oven overnight at 120° C. to form a dried gel. The resulting gel was ground finely with mortar and pestle and calcined in a muffle furnace at 800° C. for 5 h with a temperature ramp rate of 5° C. min⁻¹.

### Perovskite Structure Factors

The perovskite structure factors were calculated to predict the stability of the perovskite oxide structure. The Goldschmidt tolerance factor, t, of perovskite (ABO₃), is defined as follows:

$$t = \frac{{r}_{a} + {r}_{O}}{\sqrt{2} ( {r}_{b} + {r}_{O} )} \qquad ( 1 )$$

Octahedron factor, μ, related to octahedral unit BO₆, is defined as follows:

$$ μ = \frac{{r}_{b}}{{r}_{O}} \qquad ( 2 )$$

### Materials Characterization

The crystallographic structure of the MFMs was characterized by XRD analysis (PANalytical Empyrean Series 2) using a Cu Kα radiation source. The crystallite sizes of CaO and NiO were calculated using the Scherrer equation. The chemical composition of the surface of MFMs was obtained in an XPS using an Axis Ultra spectrometer (Kratos Analytical) equipped with an Al Kα source. The atomic resolution images and crystalline phase of the MFMs were obtained by STEM-HAADF and HRTEM using a ThermoFischer Scientific Titan Themis 300 with double spherical aberration-correctors operated at 300 kV. TPR was used to investigate the reducibility of the MFMs (50 mg) under 5% H₂/He (H₂-TPR) or 10% CH₄/He (CH₄-TPR) with total flow rate of 50 ml min⁻¹ from 100 to 800° C. with temperature ramping of 10° C. min⁻¹ after pretreatment in 20% O₂/He condition at 800° C. for 1 h in a quartz tube microreactor (Hiden Analytical CATLAB) combined with a MS spectrometer (Hiden QGA Gas Analyzer). TPO was conducted under 20 vol % O₂/He from 100 to 800° C. with a temperature ramping rate of 10° C. min⁻¹ in a quartz tube microreactor (Hiden Analytical CATLAB) and MS spectrometer (Hiden QGA Gas Analyzer) to determine the type of coke species after CH₄-treatment under 10 vol % CH₄/He with total flow rate of 50 ml min⁻¹ at 800° C. for 1 h over MFMs.

### Reaction Process

The CO₂ capture and subsequent DRM was conducted using 50 mg of MFMs in a quartz tube microreactor (Hiden Analytical CATLAB) combined with an MS spectrometer (Hiden QGA Gas Analyzer) after reduction under 5% H₂/He condition at 800° C. for 1 h. The temperature was decreased to 600, 650, and 700° C., which was maintained during the reaction. At the CO₂ capture step, 10 vol % CO₂/He flowed through the bed with 50 ml min⁻¹ total flow rate for 15 min. At the subsequent DRM step, the gas composition changed to 10 vol % CH₄ and was maintained for 15 min.

Conventional carbonation and decarbonation was carried out using 50 mg of MFMs in a quartz tube microreactor (Hiden Analytical CATLAB) combined with an MS spectrometer (Hiden QGA Gas Analyzer) after pretreatment in 20% O₂/He condition at 800° C. for 1 h. At the CO2 capture step, 10 vol % CO₂/He flowed through the bed with 50 ml min⁻¹ of total flow rate at 700° C. for 15 min. At the regeneration step, the temperature increased to 900° C. with temperature ramping of 10° C. min⁻¹ and maintained under pure He for 15 min. CO₂ capture capacity during CO₂ capture step, syngas (CO and H₂) productivity during DRM step and H₂/CO ratio were calculated following equations (3)-(5):

$${CO}_{2} capture capacity ( mmol / g ) during {CO}_{2} capture = \frac{\int \{ Inlet {CO}_{2} molar flow rate ( \text{?} ) - Outlet {CO}_{2} molar flow rate ( \text{?} ) \} \text{?}}{Weight of sample ( g )} \qquad ( 3 )$$

$$\text{?} ( CO and {H}_{2} ) productivity ( mmol / g ) during DRM = \frac{\int Produced \text{?} ( CO or {H}_{2} ) molar flow rate ( \text{?} ) \text{?}}{Weight of sample ( g )} \qquad ( 4 )$$

$${H}_{2} / {CO}_{ratio} = {H}_{2 productivity} / {CO}_{productivity} \qquad ( 5 )$$

$$\text{?} \text{indicates text missing or illegible when filed}$$

### References Cited in Example 1

[1] a) E. García-Bordejé, A. B. Dongil, J. Moral, J. M. Conesa, A. Guerrero-Ruiz, I. Rodríguez-Ramos, J. CO2 Util. 2023, 68, 102370; b) C. Jeong-Potter, A. Porta, R. Matarrese, C. G. Visconti, L. Lietti, R. Farrauto, Appl. Catal., B 2022, 310, 121294; c) S. Jo, J. H. Lee, T. Y. Kim, J. H. Woo, H.-J. Ryu, B. Hwang, S. C. Lee, J. C. Kim, K. L. Gilliard-AbdulAziz, Fuel 2022, 311, 122602; d) S. Jo, H. D. Son, T.-Y. Kim, J. H. Woo, J. C. Kim, S. C. Lee, K. L. Gilliard-AbdulAziz, Chem. Eng. J. 2023, 143772; e) S. J. Park, M. P. Bukhovko, C. W. Jones, Chem. Eng. J. 2021, 420, 130369; f) J.-H. Woo, S. Jo, J.-E. Kim, T.-Y. Kim, H.-D. Son, H.-J. Ryu, B. Hwang, J.-C. Kim, S.-C. Lee, K. L. Gilliard-AbdulAziz, Catalysts 2023, 13, 1174.
[2] S. Jo, L. Cruz, S. Shah, S. Wasantwisut, A. Phan, K. L. Gilliard-AbdulAziz, ACS Catal. 2022, 12, 7486.
[3] S. B. Jo, J. H. Woo, J. H. Lee, T. Y. Kim, H. I. Kang, S. C. Lee, J. C. Kim, Sustainable Energy Fuels 2020, 4, 4679.
[4] a) J. Hu, P. Hongmanorom, V. V. Galvita, Z. Li, S. Kawi, Appl. Catal., B 2021, 284, 119734; b) S. Jo, J. H. Lee, J. H. Woo, T.-Y. Kim, H.-J. Ryu, B. Hwang, J. C. Kim, S. C. Lee, K. L. Gilliard-AbdulAziz, Sustainable Energy Fuels 2022, 6, 81;
[5] S. Lawson, K. Baamran, K. Newport, F. Rezaei, A. A. Rownaghi, Chem. Eng. J. 2022, 431, 133224.
[6] Y. Chai, Y. Fu, H. Feng, W. Kong, C. Yuan, B. Pan, J. Zhang, Y. Sun, ChemCatChem 2018, 10, 2078.
[7] a) B. Bao, J. Liu, H. Xu, B. Liu, W. Zhang, RSC Adv. 2016, 6, 68934; b) A. Ochoa, J. Bilbao, A. G. Gayubo, P. Castaño, Renewable Sustainable Energy Rev. 2020, 119, 109600.
[8] A. Ochoa, B. Valle, D. E. Resasco, J. Bilbao, A. G. Gayubo, P. Castaño, ChemCatChem 2018, 10, 2311.
[9] H. J. Yoon, K. B. Lee, Chem. Eng. J. 2019, 355, 850.
[10] M. D. Argyle, C. H. Bartholomew, Catalysts 2015, 5, 145.
[11] Z. Lv, C. Qin, S. Chen, D. P. Hanak, C. Wu, Sep. Purif. Technol. 2021, 277, 119476.
[12] a) P. Cao, P. Tang, M. F. Bekheet, H. Du, L. Yang, L. Haug, A. Gili, B. Bischoff, A. Gurlo, M. Kunz, J. Phys. Chem. C 2021, 126, 786; b) S. Shah, J. Hong, L. Cruz, S. Wasantwisut, S. R. Bare, K. L. Gilliard-AbdulAziz, ACS Catal. 2023, 13, 3990; c) S. Shah, S. Sayono, J. Ynzunza, R. Pan, M. Xu, X. Pan, K. L. Gilliard-AbdulAziz, AIChE J. 2020, 66, e17078; d) S. Shah, M. Xu, X. Pan, K. L. Gilliard-Abdulaziz, ACS Appl. Nano Mater. 2021, 4, 8626; e) S. Shah, M. Xu, X. Pan, K. L. Gilliard-AbdulAziz, ACS Appl. Nano Mater. 2022, 5, 17476; f) J. Zhang, M.-R. Gao, J.-L. Luo, Chem. Mater. 2020, 32, 5424; g) M. Najimu, S. Jo, K. L. Gilliard-AbdulAziz, Acc. Chem. Res. 2023, 3990.
[13] Q. Ji, L. Bi, J. Zhang, H. Cao, X. S. Zhao, Energy Environ. Sci. 2020, 13, 1408.
[14] J. H. Kim, J. K. Kim, J. Liu, A. Curcio, J.-S. Jang, I.-D. Kim, F. Ciucci, W. Jung, ACS Nano 2020, 15, 81.
[15] R. Huang, C. Lim, M. G. Jang, J. Y. Hwang, J. W. Han, J. Catal. 2021, 400, 148.
[16] A. Umar, M. O. Thotyl, GCB Bioenergy 2023, 15, 791.
[17] a) C. Lin, A. C. Foucher, Y. Ji, C. D. Curran, E. A. Stach, S. McIntosh, R. J. Gorte, ACS Catal. 2019, 9, 7318; b) C. Lin, J. B. Jang, L. Zhang, E. A. Stach, R. J. Gorte, ACS Catal. 2018, 8, 7679.
a) M. Heidari, M. Tahmasebpoor, S. B. Mousavi, C. Pevida, J. CO2 Util. 2021, 53, 101747; b) C. Zhang, Y. Li, Z. He, J. Zhao, D. Wang, Appl. Catal., B 2022, 314, 121474.
[19] a) A. Ali, A. Zaman, M. K. Khan, L. B. Farhat, A. H. Jabbar, K. M. Badi, I. Ullah, V. Tirth, S. Khan, J. Supercond. Novel Magn. 2022, 35, 1987; b) H. Wu, W. Cai, C. Zhou, R. Yang, R. Gao, G. Chen, X. Deng, Z. Wang, X. Lei, C. Fu, J. Mater. Sci.: Mater. Electron. 2021, 32, 24328.
[20] Y. Li, R. Zhu, Y. Wang, L. Feng, Y. Liu, npj Computat. Mater. 2023, 9, 109.
[21] a) D. Ji, C. Liu, Y. Yao, L. Luo, W. Wang, Z. Chen, Nanoscale 2021, 13, 9952; b) T. L. Phan, N. Tran, D. H. Kim, P. T. Tho, B. T. Huy, T. N. Dang, D. S. Yang, B. Lee, J. Am. Ceram. Soc. 2018, 101, 2181.
[22] S. AlZadjali, Z. Matouk, A. AlShehhi, N. Rajput, M. Mohammedture, M. Guttierrez, Appl. Sci. 2023, 13, 1707.
[23] a) Z. Fu, J. Hu, W. Hu, S. Yang, Y. Luo, Appl. Surf. Sci. 2018, 441, 1048; b) Y. Shi, L. Wang, M. Wu, F. Wang, Appl. Catal., B 2023, 337, 122927.
[24] J. Hu, P. Hongmanorom, P. Chirawatkul, S. Kawi, Chem. Eng. J. 2021, 426, 130864.
[25] Y. Qiu, R. Gao, W. Yang, L. Huang, Q. Mao, J. Yang, L. Sun, Z. Hu, X. Liu, Chem. Mater. 2020, 32, 1864.
[26] H. Guo, S. Wang, C. Li, Y. Zhao, Q. Sun, X. Ma, Ind. Eng. Chem. Res. 2016, 55, 7873.
[27] J. Zhao, X. Cao, Y. Bai, J. Chen, C. Zhang, Optical Mater. 2023, 135, 113239.
[28] a) H. Idriss, Surf. Sci. 2021, 712, 121894; b) J. Liu, M. Liu, S. Chen, B. Wang, J. Chen, D.-P. Yang, S. Zhang, W. Du, Green Energy Environ. 2022, 7, 352.
[29] A. Salcedo, P. G. Lustemberg, N. Rui, R. M. Palomino, Z. Liu, S. Nemsak, S. D. Senanayake, J. A. Rodriguez, M. V. Ganduglia-Pirovano, B. Irigoyen, ACS Catal. 2021, 11, 8327.

The entire content of Seongbin Jo, et al., Small. 2024 Apr. 30: e2401156. doi: 10.1002/smll.202401156, titled “Self-Regenerative Ni-Doped CaTiO₃/CaO for Integrated CO₂ Capture and Dry Reforming of Methane”, are incorporated by reference herein.

All publications, patents, and patent documents are incorporated by reference herein, as though individually incorporated by reference. The invention has been described with reference to various specific and preferred embodiments and techniques. However, it should be understood that many variations and modifications may be made while remaining within the spirit and scope of the invention.

What is claimed is:

1. A multifunctional composition comprising
a) Nickel (Ni)-doped calcium titanate (CaTiO₃), and
b) calcium oxide (CaO) or calcium carbonate (CaCO₃).

2. The composition of claim 1, comprising CaO.

3. The composition of claim 1, wherein the Ni-doped CaTiO₃ has a Ni to Ti molar ratio of about 1:99 to 5:95.

4. The composition of claim 3, wherein the Ni-doped CaTiO₃ has a Ni to Ti molar ratio of about 1:99 to 3:97.

5. The composition of claim 3, wherein the Ni-doped CaTiO₃ has a Ni to Ti molar ratio of about 2:98.

6. The composition of claim 3, wherein the Ni-doped CaTiO₃ has a Ni to Ti molar ratio of about 5:95.

7. The composition of claim 2, wherein the Ni-doped CaTiO₃ comprises Ni that is socketed on the surface of CaTiO₃.

8. The composition of claim 1, comprising CaCO₃.

9. The composition of claim 8, wherein the Ni-doped CaTiO₃ comprises Ni that is incorporated within CaTiO₃ lattice.

10. The composition of claim 9, wherein the Ni-doped CaTiO₃ has a Ca to (Ni+Ti) molar ratio of about 1 to 1.1.

11. The composition of claim 9, wherein the Ni-doped CaTiO₃ has a Ca to (Ni+Ti) molar ratio of about 1.01 to 1.09.

12. The composition of claim 11, wherein the Ni-doped CaTiO₃ has a Ca to (Ni+Ti) molar ratio of about 1.01.

13. The composition of claim 11, wherein the Ni-doped CaTiO₃ has a Ca to (Ni+Ti) molar ratio of about 1.09.

14. The composition of claim 11, wherein the Ni-doped CaTiO₃ has a Ni to Ti molar ratio of about 1:99 to 5:95.

15. The composition of claim 14, wherein the Ni-doped CaTiO₃ has a Ni to Ti molar ratio of about 2:98.

16. The composition of claim 14, wherein the Ni-doped CaTiO₃ has a Ni to Ti molar ratio of about 5:95.

17. A method of capturing and/or utilizing CO₂, comprising contacting a multifunctional composition that comprises Ni-doped CaTiO₃, and CaO with CO₂.

18. The method of claim 17, wherein the multifunctional composition is converted to a composition that comprises Ni-doped CaTiO₃ and CaCO₃.

19. The method of claim 18, further comprising contacting the composition according to claim 18 with CH₄.

20. The method of claim 19, wherein CO and H₂ are produced.

21. A method of making a multifunctional composition, comprising:
mixing Ni, Ca and Ti metal precursors, a metal chelating agent, and a polymerization agent in an aqueous solution,
drying the aqueous solution to a dried gel, and
heating the dried gel to produce the multifunctional composition that comprises Ni-doped CaTiO₃, and CaO.

22. The method of claim 21, comprising
mixing Ni(NO₃)₂, Ca(NO₃)₂, Ti(C₄H₉O)₄, citric acid, and ethylene glycol butyl ether in an aqueous solution,
drying the aqueous solution to a dried gel, and
heating the dried gel at about 800° C. to produce the multifunctional composition.
